(19) United States
(12) Patent Application Publication
(10) Pub. No.: US 2016/0052199 A1
(43) Pub. Date: Feb. 25, 2016

(54) SACRIFICIAL MATERIALS

(71) Applicant: University of Massachusetts, Boston, MA (US)

(72) Inventors: Christopher John Hansen, Lowell, MA (US); Valentin Sitte, Fulda (DE); Andrew Burke, Boston, MA (US); Colin Senechal, Boston, MA (US)

(21) Appl. No.: 14/834,781

(22) Filed: Aug. 25, 2015

Related U.S. Application Data
(60) Provisional application No. 62/041,230, filed on Aug. 25, 2014.

(51) Int. Cl. B29C 65/72; B29C 65/02

(52) U.S. Cl. CPC B29C 65/72; B29C 65/02; B29K 2023/00

(57) ABSTRACT

Various embodiments disclosed relate to sacrificial materials and methods of using the same. Various embodiments provide objects having the sacrificial material at least partially removed therefrom, and methods of making the same. Various embodiments provide sacrificial adhesives, sacrificial mechanical connectors, and methods of using the same. The sacrificial material can include a polymer including a repeating unit including a substituted or unsubstituted (C₂-C₂₀)hydrocarbylene and at least one of carboxylate, carbonate, carbamate, thiocarbonate, and thiocarbamate. The method can include exposing the sacrificial material to at least one of heat and acid, such that at least some of the sacrificial material degrades. The method can include removing at least some of the degraded sacrificial material.

### CROSS-REFERENCE TO RELATED APPLICATION

This application claims the benefit of priority to U.S. Provisional Patent Application Ser. No. 62/041,230 filed Aug. 25, 2014, the disclosure of which is incorporated herein in its entirety by reference.

### STATEMENT OF GOVERNMENT SUPPORT

This invention was made with Government support under NNX14AO50G awarded by NASA. The U.S. Government has certain rights in this invention.

### BACKGROUND

Materials that can be degraded and removed from another material can be a useful processing route to form and pattern new structures. For example, degradable fibers can be used to generate materials having valuable properties, such as synthetic microvascular networks that can have low density, can be capable of transferring mass and energy, and can enable microfluidic applications.

Degradable materials often require harsh and inconvenient processing conditions to trigger degradation, preventing or hindering various uses of the degradable material, such as with temperature-sensitive materials. After degradation, degradable materials often must be subjected to inconvenient conditions for removal, such as high temperatures and vacuum for long periods of time.

### SUMMARY OF THE INVENTION

In various embodiments, the present invention provides a method including forming a composite material. The composite material includes a sacrificial material and a non-sacrificial material. The sacrificial material includes a polymer including a repeating unit including a substituted or unsubstituted (C₂-C₂₀)hydrocarbylene and at least one of carbonate, carbamate, thiocarbonate, and thiocarbamate. The method includes exposing the composite material to at least one of heat and acid, such that at least some of the sacrificial material degrades. The method also includes removing at least some of the degraded sacrificial material from the non-sacrificial material.

In various embodiments, the present invention provides a method of forming a cavitated material. The method includes forming a precursor composite material. The precursor composite material includes a sacrificial fiber in a curable composition. The sacrificial fiber includes a polymer including a repeating unit including a substituted or unsubstituted (C₂-C₂₀)hydrocarbylene and at least one of carbonate, carbamate, thiocarbonate, and thiocarbamate. The method includes curing the precursor composite material, to form a composite material. The method includes exposing the composite material to at least one of heat and acid, such that at least some of the sacrificial fibers degrade. The method also includes removing at least some of the degraded fibers, to form a cavitated material.

In various embodiments, the present invention provides a method of forming a cavitated material. The method includes forming a precursor composite material that includes a sacrificial fiber and a photoacid generator in a curable composition. The sacrificial fiber includes a polymer including at least one of poly(ethylene carbonate) and polypropylene carbonate). The method includes curing the precursor composite material, to form a composite material. The method includes exposing the photoacid generator to light such that the photoacid generator generates acid and at least some of the fibers degrade. The method also includes exposing the composite to heat and vacuum such that at least some of the degraded fibers are removed from the composite, to form a cavitated material.

In various embodiments, the present invention provides a cavitated material formed by a method including forming a precursor composite material that includes a sacrificial fiber in a curable composition. The sacrificial fiber includes a polymer including a repeating unit including a substituted or unsubstituted (C₂-C₂₀)hydrocarbylene and at least one of carbonate, carbamate, thiocarbonate, and thiocarbamate. The method includes curing the precursor composite material, to form a composite material. The method includes exposing the composite material to at least one of heat and acid, such that at least some of the sacrificial fibers degrade. The method also includes removing at least some of the degraded fibers, to form a cavitated material.

In various embodiments, the present invention provides a method of connecting components. The method includes connecting a first component and a second component via a connector including a sacrificial material.

In various embodiments, the present invention provides a method of connecting components, the method including applying a connector including a sacrificial material to a first component, a second component, or a combination thereof. The sacrificial material is about 50 wt % to about 100 wt % of the connector. The sacrificial material is a polymer that is poly(ethylene carbonate), poly(propylene carbonate), poly(lactic acid), or a combination thereof. The connector is an adhesive, a sacrificial mechanical connector, or a combination thereof. The method includes connecting the first component and the second component via the connector. The method includes disconnecting the first component and the second component including exposing the sacrificial material to at least one of heat and acid sufficiently to degrade the sacrificial material, soften the sacrificial material, or a combination thereof, such that the connector no longer mechanically connects or chemically adheres the first component to the second component.

In various embodiments, the present invention provides a method of disconnecting components. The method includes obtaining or providing a first component and a second component connected via a connector including a sacrificial material. The method also includes exposing the sacrificial material to at least one of heat and acid sufficiently to degrade the sacrificial material, soften the sacrificial material, or a combination thereof, such that the connector no longer connects the first component to the second component.

In various embodiments, the present invention provides a method of disconnecting components. The method includes obtaining or providing a first component and a second component connected via a connector including a sacrificial material. The sacrificial material is about 50 wt % to about 100 wt % of the connector. The sacrificial material is a polymer that is poly(ethylene carbonate), poly(propylene carbonate), poly(lactic acid), or a combination thereof. The connector is an adhesive, a sacrificial mechanical connector, or a combination thereof. The method also includes exposing the sacrificial material to at least one of heat and acid sufficiently to degrade the sacrificial material, soften the sacrificial material, or a combination thereof, such that the connector no longer mechanically connects or chemically adheres the first component to the second component.

In various embodiments, the present invention provides a sacrificial adhesive. The adhesive includes a sacrificial material including a polymer including a repeating unit including a substituted or unsubstituted (C₂-C₂₀)hydrocarbylene and at least one of carboxylate, carbonate, carbamate, thiocarbonate, and thiocarbamate.

In various embodiments, the present invention provides a sacrificial adhesive. The adhesive includes a sacrificial material that is poly(ethylene carbonate), poly(propylene carbonate), poly(lactic acid), or a combination thereof.

In various embodiments, the present invention provides a sacrificial mechanical connector. The connector includes a sacrificial material including a polymer including a repeating unit including a substituted or unsubstituted (C₂-C₂₀)hydrocarbylene and at least one of carboxylate, carbonate, carbamate, thiocarbonate, and thiocarbamate.

In various embodiments, the present invention provides a sacrificial material that is poly(ethylene carbonate), poly(propylene carbonate), poly(lactic acid), or a combination thereof.

Various embodiments of the present invention provide certain advantages over other sacrificial materials and methods of using the same. For example, in some embodiments, the sacrificial material can be less expensive and easier to degrade or remove than other sacrificial materials. In some embodiments, the sacrificial fibers can be used to form cavitated materials not possible or not easily achievable using other sacrificial materials.

In some embodiments, the sacrificial material can be degradable at lower temperatures than other sacrificial materials, allowing the use of more temperature sensitive materials and providing access to new cavitated materials. In various embodiments, the sacrificial materials can be degraded by acid, allowing the use of lower temperatures and providing a new and more convenient way to degrade materials. In some embodiments, the sacrificial fiber can be placed in another material with a photoacid generator, such that light can be used to generate acid and degrade the material, providing a new and more convenient way to degrade fibers. In some embodiments, the sacrificial material can be removed after degradation more easily than other materials, such as at least one of more quickly, at a lower temperature, with the use of less vacuum, with the use of less energy, and with cleaner degradation products. In some embodiments, acid generated by the photoacid generator can be used to modify the cure chemistry of a surrounding curable composition, providing materials having new and useful properties.

In various embodiments, the connector including the sacrificial material can provide new applications of adhesives or fasters for bonding various components. Typical adhesives and mechanical connectors cannot de-bond or de-fasten; however, in various embodiments, the connector can be easily de-bonded or degraded using heat, acid, or a combination thereof. In various embodiments, application of sufficient heat can completely degrade the connector, such that little or no residue remains after degradation. In various embodiments, the connector is conveniently de-bondable or degradable at low temperatures, allowing de-bonding or unfastening of temperature-sensitive components. In various embodiments, the sacrificial adhesive can adhere to various components at low temperatures, allowing bonding of temperature-sensitive components.

### BRIEF DESCRIPTION OF THE FIGURES

The drawings illustrate generally, by way of example, but not by way of limitation, various embodiments discussed in the present document.

FIG. 1 illustrates weight loss for various poly(lactic acid) samples, in accordance with various embodiments.

FIG. 2 illustrates cumulative probability versus % mass loss for samples placed at various positions in the vacuum oven, in accordance with various embodiments.

FIG. 3 illustrates weight loss for poly(propylene carbonate) samples at various temperatures, in accordance with various embodiments.

FIG. 4 illustrates weight loss for various poly(propylene carbonate) samples, in accordance with various embodiments.

FIG. 5 illustrates weight loss for various poly(propylene carbonate) samples including a photoacid generator, in accordance with various embodiments.

FIG. 6 illustrates weight loss and temperature versus time for a poly(propylene carbonate) sample including a photoacid generator, in accordance with various embodiments.

FIG. 7 illustrates weight loss and temperature versus time for a poly(propylene carbonate) sample including a photoacid generator, in accordance with various embodiments.

FIG. 8 illustrates weight loss and temperature versus time for a poly(propylene carbonate) sample including a photoacid generator, in accordance with various embodiments.

FIG. 9 illustrates weight loss and temperature versus time for a poly(propylene carbonate) sample including a photoacid generator, in accordance with various embodiments.

FIG. 10 illustrates weight loss and temperature versus time for a poly(propylene carbonate) sample including a photoacid generator, in accordance with various embodiments.

FIG. 11 illustrates weight loss and temperature versus time for various poly(lactic acid) samples, in accordance with various embodiments.

FIG. 12A illustrates PLA fiber being melted and printed by a three-dimensional print head, in accordance with various embodiments.

FIG. 12B illustrates the three-dimensionally printed PLA fiber, in accordance with various embodiments.

FIG. 13 is a reproduction of a photograph of three-dimensionally printed joints of PLA, in accordance with various embodiments.

FIG. 14 is a reproduction of a photograph of a two-strut joint, in accordance with various embodiments.

FIG. 15A is a reproduced photograph of two carbon fiber/epoxy plates prior to being bonded with PLA, in accordance with various embodiments.

FIG. 15B is a reproduced photograph of two carbon fiber/epoxy plates after being bonded with PLA, in accordance with various embodiments.

FIG. 16 illustrates a photograph of an apparatus used to test the tensile strength of two carbon fiber/epoxy plates bonded together using PLA adhesive.

FIG. 17A is a reproduced photograph of two carbon fiber/epoxy plates bonded with PLA after mechanical separation of the plates.

FIG. 17B is a reproduced photograph of two carbon fiber/epoxy plates bonded with PLA after separation of the plates via heating.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.” All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “heterocyclyl” as used herein refers to aromatic and non-aromatic ring compounds containing three or more ring members, of which one or more is a heteroatom such as, but not limited to, N, O, and S.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “UV light” as used herein refers to ultraviolet light, which is electromagnetic radiation with a wavelength of about 10 nm to about 400 nm.

The term “cure” as used herein refers to exposing to radiation in any form, heating, or allowing to undergo a physical or chemical reaction that results in hardening or an increase in viscosity.

The term “solvent” as used herein refers to a liquid that can dissolve a solid, liquid, or gas. Nonlimiting examples of solvents are silicones, organic compounds, water, alcohols, ionic liquids, and supercritical fluids.

As used herein, the term “polymer” refers to a molecule having at least one repeating unit and can include copolymers.

### Part I. Composite and Cavitated Material.

### Method of Forming a Composite.

In various embodiments, the present invention provides a method that can include forming a composite material that includes a sacrificial material and a non-sacrificial material (e.g., a composite of a sacrificial material and a non-sacrificial material). The sacrificial material and the non-sacrificial material can be in any suitable arrangement with one another provided they are in physical contact. In some embodiments, the sacrificial material is embedded in the non-sacrificial material. The sacrificial material can have any suitable shape, such as planar, spherical, irregular, or cylindrical. Forming the composite material can include any suitable method of combining the sacrificial material and the non-sacrificial material, such as placing the sacrificial material in a curable composition and curing the composition, or such as placing the sacrificial material in a thermoplastic material. The composite material can have any suitable size and shape, such as one-dimensional, planar, cubical, spheroid, cylindrical, or irregular. The method can include exposing the composite material to conditions suitable to at least partially degrade at least some of the sacrificial material, such as at least one of heat and acid. The method can also include removing at least some of the degraded sacrificial material from the non-sacrificial material, such as by subjecting the composite to conditions sufficient to vaporize the degraded sacrificial material such that it can diffuse out of the composite. The method can include subjecting the composite material to any other suitable processing (e.g., extrusion, melting, shaping, compression, and the like) at any stage of the method, such as before degradation of the sacrificial material or after degradation or the sacrificial material, and such as before removal of the sacrificial material or after removal of the sacrificial material.

In various embodiments, the present invention provides a method of forming a cavitated material. The method can include forming a precursor composite material that includes a sacrificial fiber in a curable composition. In some embodiments, forming the precursor composite material can include arranging the sacrificial fiber in the curable composition, such as in a pre-determined (e.g., woven, 2D pattern, or 3D pattern) or random pattern. The method can include forming or curing the precursor composite material, to at least partially cure a curable composition or form a thermally formable composite in order to form a composite material. The method can include exposing the composite material to at least one of heat and acid (e.g., acid formed from a photoacid generator or from another acid source), such that at least some of the sacrificial fibers degrade. The method can include removing at least some of the degraded fibers, to form the cavitated material.

In various embodiments, the invention provides a method of using a filamentary or fiber degradable material to generate a cavitated system in a layer of block of material, such as in a polymer. In some embodiments, the degradable material can include at least one of poly(ethylene carbonate) and polypropylene carbonate). The degradable material can be optionally combined with a photo-acid generator. These filaments or fibers can be woven or otherwise incorporated into structures (e.g., fiber-reinforced composites) and subsequently decomposed by thermal, chemical, or solvent means to obtain embedded cavities (e.g., microvascular channels or pores). In various embodiments, the degradable fiber can be placed into the polymer before it is formed (e.g., before or as it is cured from monomer or a melt) and the fiber can be later degraded and removed, leaving behind the vascular system.

### Sacrificial Material.

In various embodiments, the present invention provides a sacrificial material. Embodiments of the present invention include any suitable method of using the sacrificial material. In various embodiments, the sacrificial material can be degraded using less extreme conditions such as lower temperatures than possible with other degradable materials. The sacrificial material can have any suitable size and shape. In some embodiments, the sacrificial material can be any suitable shape, such as planar, spherical, irregular, or cylindrical (e.g., fibers), and can have any suitable dimensions, such that the sacrificial material can be used as described herein. The fibers can be formed by any suitable method, such as by at least one of extrusion, spinning (e.g., solvent spinning), and printing (e.g., three-dimensional printing). The fibers can have any suitable dimensions, such as a diameter of about 0.001 μm to about 5 mm, about 50 μm to about 1 mm, or about 0.001 μm or less, or less than, equal to, or more than about 0.005 μm, 0.01, 0.05, 0.1, 0.5, 1, 2, 3, 4, 5, 10, 15, 20, 25, 50, 75, 100, 150, 200, 250, 500, 750 μm, 1 mm, 1.5, 2, 2.5, 3, 3.5, 4, 4.5, or about 5 mm or more, and such as a length of about 1 μm to about 50 km, 1 μm to about 1 km, 1 μm to about 50 m, about 100 μm to about 10 m, or about 1 μm or less, or less than, equal to, or more than about 5 μm, 10, 20, 50, 100, 250, 500 μm, 1 mm, 5, 10, 15, 20, 25, 50, 75, 100, 150, 200, 250, 500, 750 mm, 1 m, 2, 3, 4, 5, 10, 20, 30, 40, 50, 100, 150, 200, 250, 500, 750 m, 1 km, 1.5 km, 2, 3, 4, 5, 10, 15, 20, 30, 40, or about 50 km or more.

The sacrificial material can include any suitable material that can be degraded and removed from another material. In various embodiments, the sacrificial material includes one or more polymers that include a repeating unit comprising a substituted or unsubstituted (C₂-C₂₀)hydrocarbylene and at least one of carbonate, carbamate, thiocarbonate, and thiocarbamate. The substituted or unsubstituted (C₂-C₂₀)hydrocarbylene and the carbonate, carbamate, thiocarbonate, or thiocarbamate can be part of the backbone of the polymer, e.g., non-pendant groups. The polymer can include a repeating unit that is a (C₂-C₅)hydrocarbylene carbonate, e.g., ethylene carbonate, propylene carbonate, butylene carbonate, or pentylene carbonate. The polymer can include a repeating unit that is a substituted or unsubstituted ethylene carbonate, such as substituted with one or more substituted or unsubstituted (C₁-C₁₀)hydrocarbyl groups. The polymer can include a repeating unit that is ethylene carbonate or propylene carbonate (e.g., ethylene carbonate having a methyl group substituted on the ethylene group). In some embodiments the polymer is poly(ethylene carbonate) or poly(propylene carbonate) (e.g., wherein the propylene is bonded at the 1- and 2-positions). In some embodiments, the polymer is a poly(ethylene carbonate) copolymer or a poly(propylene carbonate) copolymer. In some embodiments, the polymer is a poly(ethylene carbonate)-poly(propylene carbonate) copolymer).

Any suitable proportion of the sacrificial material can be the degradable material such as a degradable polymer. For example, in some embodiments, degradation and removal of only part of a sacrificial fiber can be sufficient to generate the desired cavities (e.g., microvascular channels or pores). In various embodiments, about 10 wt % to about 100 wt % of the sacrificial material is the one or more polymers including the repeating unit including a substituted or unsubstituted (C₂-C₂₀)hydrocarbylene and at least one of carbonate, carbamate, thiocarbonate, or about 50 wt % to about 99.9 wt %, or about 75 wt % to about 99.9 wt %, or about 10 wt % or less, or less than, equal to, or more than about 15 wt %, 20, 25, 30, 35, 40, 45, 50, 55, 60, 65, 70, 75, 80, 85, 90, 91, 92, 93, 94, 95, 96, 97, 98, 99, 99.9, 99.99, or about 99.999 wt % or more. The remainder of the sacrificial material can be any suitable one or more components, such as one or more catalysts, acid generators, particulate fillers, stabilizers, antioxidants, flame retardants, plasticizers, colorants, dyes, fragrances, or adhesion promoter.

Any suitable proportion of the composite material or the precursor composite material can be the degradable material (e.g., the degradable fibers), such as about 0.000,1 wt % to about 90 wt %, or about 0.1 wt % to about 20 wt %, or about 0.000,1 wt % or less, or less than, equal to, or more than about 0.001 wt %, 0.01, 0.1, 1, 2, 4, 6, 8, 10, 12, 14, 16, 18, 20, 25, 30, 35, 40, 45, 50, 55, 60, 65, 70, 75, 80, 85, or about 90 wt % or more.

The polymer can have any suitable molecular weight, such as about 100 g/mol to about 10,000,000 g/mol, or about 100 g/mol or less, or less than, equal to, or more than about 200 g/mol, 300, 400, 500, 750, 1,000, 1,500, 2,000, 2,500, 5,000, 10,000, 15,000, 20,000, 25,000, 50,000, 100,000, 200,000, 500,000, 1,000,000, 5,000,000, or about 10,000,000 g/mol or more.

### Curable Composition.

The method can include forming a precursor composite material that includes a sacrificial fiber in a curable composition. The method can including curing the precursor composite material, to at least partially cure the curable composition and form a composite material.

The curable composition can include any one or more suitable curable materials, in any suitable proportion, such that the curable composition can be hardened via curing, and such that the degradable materials can be suitably degraded and removed. In various embodiments, the curable composition can be cured to formed a cured composition having a melting point or softening point that is higher than the temperature used for degradation and removal of the degradable material, taking into account the use of an optional acid or an optional photoacid generator used during the degradation which can lower the temperature needed for degradation.

The curable composition can include at least one of a thermoset composition, a thermoplastic composition (e.g., having a higher melting point than the degradation temperature of the degradable material), a polymerizable composition, and a crosslinkable composition, such as about 10 wt % to about 100 wt %, or about 50 wt % to about 99.999%, or about 10 wt % or less, or less than, equal to, or more than about 15 wt %, 20, 25, 30, 35, 40, 45, 50, 55, 60, 65, 70, 75, 80, 85, 90, 91, 92, 93, 94, 95, 96, 97, 98, 99, 99.5, 99.9, 99.99, or about 99.999 wt % or more.

The curable composition or the cured product thereof (e.g., the curable composition can include monomers or partially polymerized monomers that can polymerize to form the cured product, and can optionally include any suitable catalyst) can include a polyamide such as nylon; a polyester such as poly(ethylene terephthalate) or polycaprolactone; a polycarbonate; a polyether; an epoxy polymer; an epoxy vinyl ester polymer; a polyimide such as polypyromellitimide; a phenol-formaldehyde polymer; an amineformaldehyde polymer such as a melamine polymer; a polysulfone; a poly(acrylonitrile-butadiene-styrene) (ABS); a polyurethane; a polyolefin such as polyethylene, polystyrene, polyacrylonitrile, a polyvinyl, polyvinyl chloride, or poly(dicyclopentadiene); a polyacrylate such as poly(ethyl acrylate); a poly(alkylacrylate) such as poly(methyl methacrylate); a polysilane such as poly(carborane-silane); and a polyphosphazene.

The curable composition can include an elastomer, such as an elastomeric polymer, an elastomeric copolymer, an elastomeric block copolymer, and an elastomeric polymer blend. Examples of elastomer polymers can include polyolefins, polysiloxanes such as poly(dimethylsiloxane) (PDMS), polychloroprene, and polysulfides; examples of copolymer elastomers may include polyolefin copolymers and fluorocarbon elastomers; examples of block copolymer elastomers may include acrylonitrile block copolymers, polystyrene block copolymers, polyolefin block copolymers, polyester block copolymers, polyamide block copolymers, and polyurethane block copolymers; and examples of polymer blend elastomers include mixtures of an elastomer with another polymer. The curable composition can include a mixture of these polymers, including copolymers that include repeating units of two or more of these polymers, and/or including blends of two or more of these polymers.

The curable composition can include other ingredients in addition to the curable material. For example, the curable composition can include one or more catalysts, acid generators, solvents, crosslinkers, particulate fillers, stabilizers, antioxidants, flame retardants, plasticizers, colorants, dyes, fragrances, or adhesion promoters. An adhesion promoter is a substance that increases the adhesion between two materials, such as the adhesion between two polymers, or between a curable composition or a cured product thereof and a degradable fiber.

In various embodiments, the curable composition, the sacrificial fibers, or a combination thereof, include reinforcing fibers or reinforcing materials that are not degradable, such as an inorganic or an organic material, such as graphite (e.g., Thornal 25 and Modmor), ceramic, metal oxide (e.g., titanium oxide, zirconium oxide, and aluminum oxide), silica, glass, metal, and polymer (e.g., polyester, nylon, rayon, polyaramid)

### Degradation and Removal of the Sacrificial Material.

The method can include at least partially degrading the degradable material and at least partially removing the degraded degradable material. The degradation can occur in any suitable way, such as by application of at least one of heat, solvent, and chemicals such as acid or another suitable chemical.

In some embodiments, the degrading of the degradable material can include subjecting the composite material to acid. The acid can be any suitable acid, including mineral acids such as HCl, H₂SO₄, HNO₃, HF, or such as suitable organic acid. The acid can be sufficient to generate a pH of less than 7, such as about −2 or less, −1.5, −1, −0.5, 0, 0.5, 1, 1.5, 2, 2.5, 3, 3.5, 4, 4.5, 5, 5.5, 6, or about 6.5 or more. The acid can come from any suitable source. The acid can be added to the composite, such as via immersion of the composite in an acidic solution, such that the degradable fibers are exposed to the acid. The acid can be generated from within the composite, such as via use of one or more acid generators, such as one or more photoacid generators or one or more thermolytic acid generators. In some embodiments, and acid generator such as a photoacid generator can affect the curing process of the curable composition, such as by accelerating or enhancing the curing process of the curable composition nearby the degradable fibers. In various embodiments, acceleration or enhancement of the curing process near the fiber can make the composite better retain its shape after degradation of the fiber.

A photoacid generator can be placed in the composite in any suitable way. In some embodiments, the photoacid generator is part of the curable composition. In some embodiments, the photoacid generator is part of the fibers, such as distributed within the fibers (e.g., via direct mixing with the material that forms the fibers or via chemical infusion after the fibers are formed such after extrusion or spinning) or as a coating on the outside of the fibers.

The photoacid generator can be any suitable photoacid generator, such that the method can be performed as described herein. For example, the photoacid generator can be at least one of bis(4-tert-butylphenyl)iodonium perfluoro-1-butanesulfonate, bis(4-tert-butylphenyl)iodonium p-toluenesulfonate, bis(4-tert-butylphenyl)iodonium triflate, boc-methoxyphenyldiphenylsulfonium triflate, (4-bromophenyl)diphenylsulfonium triflate, (tert-butoxycarbonylmethoxynaphthyl)-diphenylsulfonium triflate, (4-tert-butylphenyl)diphenylsulfonium triflate, diphenyliodonium, diphenyliodonium nitrate, diphenyliodonium perfluoro-1-butanesulfonate, diphenyliodonium p-toluenesulfonate, diphenyliodonium triflate, (4-fluorophenyl)diphenylsulfonium triflate, N-hydroxynaphthalimide triflate, N-hydroxy-5-norbornene-2,3-dicarboximide perfluoro-1-butanesulfonate, (4-iodophenyl)diphenylsulfonium triflate, (4-methoxyphenyl)diphenylsulfonium triflate, 2-(4-methoxystyryl)-4,6-bis(trichloromethyl)-1,3,5-triazine, (4-methylphenyl)diphenylsulfonium triflate, (4-methylthiophenyl)methyl phenyl sulfonium triflate, (4-phenoxyphenyl)diphenylsulfonium triflate, (4-phenylthiophenyl)diphenylsulfonium triflate, triarylsulfonium hexafluorophosphate, triphenylsulfonium perfluoro-1-butanesufonate, triphenylsulfonium triflate, tris(4-tert-butylphenyl)sulfonium perfluoro-1-butanesulfonate, and tris(4-tert-butylphenyl)sulfonium triflate. The photoacid generator can be 4-isopropyl-4′-methyldiphenyliodonium tetrakis(pentafluorophenyl)borate (IMTPB). The photoacid generator can be any suitable proportion of the precursor composite material or of the degradable fibers, such as about 0.000,1 wt % to about 30 wt %, or about 0.1 wt % to about 5 wt %, or about 0.000,1 wt % or less, or less than, equal to, or more than about 0.000,5 wt %, 0.001, 0.005, 0.01, 0.05, 0.1, 0.5, 1, 2, 3, 4, 5, 6, 8, 10, 12, 14, 16, 18, 20, 22, 24, 26, 28, or about 30 wt % or more.

The degradation can include exposing an acid generator to conditions suitable for the acid generator to generate acid, such as suitable amounts of at least heat or light. For example, generating the acid using a photoacid generator can include exposing to suitable amounts of light. In some embodiments, the light can be UV light. The light can be light including 248 nm wavelength light (e.g., for IMPTB). In some embodiments, the thickness of the composite can be sufficient to block light from photoacid generator within the composite; some embodiments of the invention include forming an intermediate layer of curable material and degradable fiber, curing the curable material, subjecting the layer to sufficient light to activate the photoacid generator, and forming a subsequent layer of curable material and degradable fiber. A process including forming multiple layers can include repeating the steps of forming, curing, and activating the photoacid generator until the desired cavitated material is formed.

The removing of the degraded degradable material can be performed in any suitable way. In some embodiments, a suitable solvent can be used to dissolve or wash away the degraded components. In some embodiments, at least one of heat and vacuum can be used to cause the degraded components to at least partially vaporize such that they can diffuse out of the composite. The removing can include exposing to a suitable temperature, such as about 50° C. to about 500° C., or about 110° C. to about 130° C., or less than about 200° C., 195, 190° C., or less than 180° C., or about 50° C. or less, or less than, equal to, or more than about 60° C., 70, 80, 90, 100, 105, 110, 115, 120, 125, 130, 135, 140, 145, 150, 155, 160, 165, 170, 175, 180, 185, 190, 195, 200, 210, 220, 230, 240, 250, 260, 280, 300, 325, 350, 375, 400, 450, or about 500° C. or more. In some embodiments, the removing includes exposing to no vacuum (e.g., using ambient pressure). The removing can include exposing to a suitable vacuum, such as about 0.000,1 mm Hg to about 750 mm Hg, about 0.000,1 mm Hg to about 300 mm Hg, or about 20 mm Hg to about 30 mm Hg, or about 0.000,1 mm Hg or less, or less than, equal to, or more than about 0.001 mm Hg, 0.01, 0.1, 1, 2, 3, 4, 5, 6, 8, 10, 12, 14, 16, 18, 20, 22, 24, 26, 28, 30, 40, 50, 60, 70, 80, 90, 100, 150, 200, 250, 300, 350, 400, 450, 500, 550, 600, 650, 700, or about 750 mm Hg or more. The removing can include exposing to the suitable temperature and suitable vacuum for any suitable amount of time, such as less than 1 h, less than 50 minutes, 40, 35, 30, 25, or less than 20 minutes, such as about 1 second or less, or less than, equal to, or more than about 5 seconds, 10, 20, 30, 40, 50 second, 1 minute, 2, 3, 4, 5, 10, 15, 20, 25, 30, 35, 40, 45, 50, 55 minutes, 1 hour, 1.2, 1.4, 1.6, 1.8, 2, 3, 4, 5, 6, 7, 8, 9, 10, 15, 20 h, 1 day, 1.5, 2, 3, 4, 5, 6 days, 1 week, 2 weeks, or about 1 month or more.

### Cavitated Material.

In various embodiments, the present invention provides an object made by any method described herein. In various embodiments, the present invention provides a cavitated material. The cavitated material can be any suitable cavitated material made by any embodiment of the method described herein. The cavitated material can have any suitable size and shape, such as one-dimensional, planar, cubical, spheroid, cylindrical, or irregular. The cavitated material can be at least one of a microvascular material, a porous material, and a patterned porous material; e.g., the cavities in the cavitated material can be a microvascular structure, a porous structure, wherein the microvasculature or pores can be patterned or randomly distributed. The cavities can be substantially tubular, and can have any suitable arrangement, such as patterned, woven, or random. The cavitated material can be a material having new or improved properties, such as a modified material having a lower mass than a corresponding unmodified material (e.g., not having cavities or microchannels therein). The cavities in the material can be used for self-healing, heat recovery, energy transfer, mass transfer, and the like; various embodiments of the present invention provide a method of using the cavitated material, such as including introducing a fluid into the cavitated material. The cavitated material can have various uses, such as involving flowing fluids through the material. The flowing fluid can be used to cool or heat the material or can contain components for the self-healing of the material. As used herein, the term “fluid” can refer to a liquid or a gas.

### Part II. Connector Including a Sacrificial Material.

### Method of Connecting Components.

In various embodiments, the present invention provides a method of connecting components. The method can include connecting a first component and a second component via a connector. The connector includes a sacrificial material. The connector can be an adhesive material, a mechanical connecting component, or a combination thereof.

The connector can be an adhesive material. The connecting of the first component and the second component via the connector can include adhering the first component to the second component with the connector, wherein the adhering can include or be free of a mechanical, non-chemical, non-adhesive connection. Adhering the first component to the second component with the connector can include applying the connector to the first component, the second component, or both, before connecting the first component to the second component via the connector. The connector can be applied in any suitable way, such as placing (e.g., in the form of a molten liquid or a solid such as a fiber or pellet), spraying, brushing, coating, dipping, pouring, dripping, melting (e.g., placing, then melting), extruding, printing (e.g., three-dimensional printing), or a combination thereof. In embodiments wherein the connector is applied in a solid or non-softened form (e.g., below the glass transition temperature), the connecting can include heating the sacrificial material prior to or during the connecting of the first and second component. The heating can include any suitable heating such that the method can be carried out as described herein, such as about 50° C. to about 500° C., or about 110° C. to about 130° C., or less than about 200° C., 195, 190° C., or less than 180° C., or about 50° C. or less, or less than, equal to, or more than about 60° C., 70, 80, 90, 100, 105, 110, 115, 120, 125, 130, 135, 140, 145, 150, 155, 160, 165, 170, 175, 180, 185, 190, 195, 200, 210, 220, 230, 240, 250, 260, 280, 300, 325, 350, 375, 400, 450, or about 500° C. or more. The heating can be conducted for a suitable duration such that the connector is softened or liquefied. The connecting can include pressing the first component and the second component together with the connector in-between. The connecting can include allowing the connector to cool such that the first and second component are adhered together via the connector, such as below the glass transition temperature of the connector. The cooling can be passive cooling (e.g., via ambient air) or active cooling (e.g., via dipping in a cooling bath or blowing cool air on the connection). The resulting connection between the first and second component can have any suitable tensile strength, such as about 0.01 g/mm² to about 100,000 g/mm², about 0.01 g/mm² to about 1,000 g/mm², about 0.4 g/mm to about 0.8 g/mm², or less than 0.01 g/mm², or less than, equal to, or greater than about 0.1 g/mm², 0.2, 0.3, 0.4, 0.5, 0.6, 0.7, 0.8, 0.9, 1, 1.2, 1.4, 1.6, 1.8, 2, 2.2, 2.4, 2.6, 2.8, 3, 3.5, 4, 4.5, 5, 6, 7, 8, 9, 10, 12, 14, 16, 18, 20, 25, 30, 35, 40, 45, 50, 60, 70, 80, 90, 100, 125, 150, 175, 200, 250, 300, 350, 400, 450, 500, 600, 700, 800, 900, 1,000, 1,500, 2,000, 2,500, 5,000, 10,000, 15,000, 20,000, 25,000, 50,000, 75,000, or about 100,000 g/mm² or more.

The connector can be a mechanical connector. The connecting can include mechanically attaching the first component to the second component via the connect, wherein the mechanical connection can include or can be free of bonding, chemical adhesion, and non-mechanical bonding. The mechanical connector is a sacrificial mechanical connector, such as a sacrificial fastener. As used herein, “fastener” refers to a device that mechanically joins or affixes two or more components together. The sacrificial fastener can be a nail, bolt, nut, screw, clip, clamp, clasp, latch, dowel, biscuit, staple, cable, strap, thread, tie, pin, peg, hook and loop fastener, rivet, zipper, wedge anchor, or a combination thereof. In some embodiments, the connector is a combination of a mechanical connector and an adhesive, wherein the mechanical connector, the adhesive, or both, can include a sacrificial material. In some embodiment, the connector can be a mechanical connector having a coating of adhesive thereon, such as in the portions of the connector that contact the first component, the second component, or a combination thereof, wherein the adhesive, the mechanical connector, or a combination thereof, can include a sacrificial material.

The sacrificial fastener can include one or more connecting rods extending therefrom, wherein the connecting rods are designed to connect to first component, second component, or a combination thereof. The one or more connecting rods can extend from a central component of the fastener. At least one connecting rod can include the sacrificial material, the central component of the fastener includes the sacrificial material, or a combination thereof. In various embodiments, at least one connecting rod can be free of sacrificial material, or the central component of the fastener can be free of sacrificial material. The central component can have any suitable shape, such as approximately spheroid, toroid, ovoid, ring-shaped, square-shaped, or circular. At least one of the first and second components can include a rod-receiving anchor, wherein the connecting can include securely inserting (e.g., friction fit, mechanical interlock, or a combination thereof) at least one of the connecting rods into a rod-receiving anchor on the first or second component. The rod-receiving anchor can include or can be a bore in the first or second component, such as an approximately central bore. The sacrificial material can include at least two connecting rods extending therefrom, wherein the first and second components each include a rod-receiving anchor, wherein the connecting includes securely inserting a connecting rod into the rod-receiving anchor on the first component and securely inserting a different connecting rod into the rod-receiving anchor on the second component.

The first and second component can be any suitable type of material. The first and second components can be the same materials, or different materials. The first and second component can be any suitable first and second component that can be connected via the connector as described herein. The first and second component can independently include metal, metallic alloy, wood, polymer, plastic, ceramic, cement, rock, a composite (e.g., a carbon-fiber cloth impregnated with a cured resin, such as a cured epoxy resin), or a combination thereof. In some embodiments, the first and second component can include or can be a carbon-fiber cloth impregnated with a cured resin, such as a cured epoxy resin. The first component, the second component, or both, can be substantially free of sacrificial materials.

In some embodiments, the first or second component can be a mechanical connector, such as any mechanical connector or fastener described herein, wherein the mechanical connector is free of sacrificial materials. The connector can be or can include a sacrificial adhesive. The connector can be a coating of sacrificial adhesive, such as on the non-sacrificial mechanical connector. The connection between the component and the mechanical connector can be secure until the sacrificial adhesive connector is subjected to heat or acid, causing the mechanical connector to release from the component. The non-sacrificial mechanical connector can be connected to any suitable number of other components (e.g., third component, fourth component, and the like).

In various embodiments, the first and second component, the first and second component connected via the connector, or a combination thereof, can be components useful in the aerospace industry, in the automotive industry, or in the energy industry. In some embodiments, the first and second component include aerospace components, automotive components, energy industry components, or a combination thereof. In some embodiments, the first component connected to the second component via the connector is an aerospace component, an automotive component, an energy industry component, or a combination thereof.

### Sacrificial Material.

The sacrificial material in the connector can include a polymer including a repeating unit including a substituted or unsubstituted (C₂-C₂₀)hydrocarbylene and at least one of carboxylate, carbonate, carbamate, thiocarbonate, and thiocarbamate. The carboxylate, carbonate, carbamate, thiocarbonate, or thiocarbamate groups can occur in the backbone of the polymer. The sacrificial material can include one polymer, or more than one polymer. The connector can include one sacrificial material, or more than one sacrificial material. Any suitable proportion of the sacrificial material can be the one or more polymers, such as about 0.001 wt % to about 100 wt %, about 50 wt % to about 100 wt %, or about 0.001 wt % or less, or less than, equal to, or more than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 wt % or more. Any suitable proportion of the connector can be the one or more sacrificial materials, such as about 0.001 wt % to about 100 wt %, about 50 wt % to about 100 wt %, or about 0.001 wt % or less, or less than, equal to, or more than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 91, 92, 93, 94, 95, 96, 97, 98, 99, 99.9, 99.99, or about 99.999 wt % or more.

The polymer can include a repeating unit that is a (C₂-C₂₀)hydrocarbylene carbonate or carboxylate, wherein the (C₁-C₂₀)hydrocarbylene is substituted or unsubstituted. The polymer can include a repeating unit that is a (C₂-C₅)hydrocarbylene carboxylate. The polymer can include a repeating unit that is a propylene carboxylate. The polymer can be poly(lactic acid). The sacrificial material can include poly(lactic acid) and a catalyst such as tin(II) oxide.

The polymer can include a repeating unit that is a (C₂-C₅)hydrocarbylene carbonate. The polymer can include a repeating unit that is ethylene carbonate or propylene carbonate. The polymer can be poly(ethylene carbonate) or poly(propylene carbonate).

The sacrificial material can further include a catalyst, such as to catalyze the degradation of the sacrificial material, enabling degradation at lower temperature than possible without the catalyst. The sacrificial material can include one catalyst, or more than one catalyst. The catalyst can be a metal oxalate, such as aluminum oxalate, ammonium niobate(V) oxalate hydrate, ammonium oxalate, antimony oxalate, barium oxalate, beryllium oxalate, bismuth oxalate, cadmium oxalate, calcium oxalate, calcium oxalate hydrate, calcium oxalate monohydrate, cerium oxalate, cesium oxalate, chromium oxalate, cobalt oxalate, cobalt(II) oxalate dihydrate, copper oxalate, dysprosium oxalate, dysprosium(III) oxalate hydrate, erbium oxalate, erbium(III) oxalate hydrate, europium oxalate, gadolinium oxalate, gadolinium(III) oxalate hydrate, holmium oxalate, iron(II) oxalate, iron oxalate, lanthanum oxalate, lead oxalate, lithium oxalate, lutetium oxalate, lutetium oxalate hydrate, magnesium oxalate, molybdenum oxalate, neodymium oxalate, nickel oxalate, nickel(II) oxalate dihydrate, niobium oxalate, palladium oxalate, potassium oxalate anhydrous, potassium oxalate monohydrate, praseodymium oxalate, praseodymium oxalate decahydrate, rubidium oxalate, ruthenium oxalate, samarium oxalate, silver oxalate, sodium oxalate, strontium oxalate, tantalum oxalate, terbium oxalate, thulium oxalate, tin(II) oxalate, titanium oxalate, ytterbium oxalate, yttrium oxalate, zinc oxalate, zirconium oxalate, or a combination thereof. The catalyst can be tin(II) oxalate. The catalyst can be any suitable proportion of the sacrificial material, such as about 0.001 wt % to about 30 wt % of the sacrificial material, about 0.1 wt % to about 10 wt %, about 0.001 wt % or less, or less than, equal to, or more than about 0.005, 0.01, 0.05, 0.1, 0.5, 1, 2, 3, 4, 5, 6, 8, 10, 12, 14, 16, 18, 20, 22, 24, 26, 28, or about 30 wt % or more.

The polymer can have any suitable molecular weight, such as about 100 g/mol to about 10,000,000 g/mol, or about 100 g/mol or less, or less than, equal to, or more than about 200 g/mol, 300, 400, 500, 750, 1,000, 1,500, 2,000, 2,500, 5,000, 10,000, 15,000, 20,000, 25,000, 50,000, 100,000, 200,000, 500,000, 1,000,000, 5,000,000, or about 10,000,000 g/mol or more.

### Acid Generator.

In various embodiments, the connector includes an acid generator. The acid generator can be a one or more photoacid generators or one or more thermolytic acid generators.

The photoacid generator can be any suitable photoacid generator, such that the method can be performed as described herein. For example, the photoacid generator can be at least one of bis(4-tert-butylphenyl)iodonium perfluoro-1-butanesulfonate, bis(4-tert-butylphenyl)iodonium p-toluenesulfonate, bis(4-tert-butylphenyl)iodonium triflate, boc-methoxyphenyldiphenylsulfonium triflate, (4-bromophenyl)diphenylsulfonium triflate, (tert-butoxycarbonylmethoxynaphthyl)-diphenylsulfonium triflate, (4-tert-butylphenyl)diphenylsulfonium triflate, diphenyliodonium, diphenyliodonium nitrate, diphenyliodonium perfluoro-1-butanesulfonate, diphenyliodonium p-toluenesulfonate, diphenyliodonium triflate, (4-fluorophenyl)diphenylsulfonium triflate, N-hydroxynaphthalimide triflate, N-hydroxy-5-norbornene-2,3-dicarboximide perfluoro-1-butanesulfonate, (4-iodophenyl)diphenylsulfonium triflate, (4-methoxyphenyl)diphenylsulfonium triflate, 2-(4-methoxystyryl)-4,6-bis(trichloromethyl)-1,3,5-triazine, (4-methylphenyl)diphenylsulfonium triflate, (4-methylthiophenyl)methyl phenyl sulfonium triflate, (4-phenoxyphenyl)diphenylsulfonium triflate, (4-phenylthiophenyl)diphenylsulfonium triflate, triarylsulfonium hexafluorophosphate, triphenylsulfonium perfluoro-1-butanesufonate, triphenylsulfonium triflate, tris(4-tert-butylphenyl)sulfonium perfluoro-1-butanesulfonate, and tris(4-tert-butylphenyl)sulfonium triflate. The photoacid generator can be 4-isopropyl-4′-methyldiphenyliodonium tetrakis(pentafluorophenyl)borate (IMTPB). The photoacid generator can be any suitable proportion of the connector, such as about 0.000,1 wt % to about 30 wt %, or about 0.1 wt % to about 5 wt %, or about 0.000,1 wt % or less, or less than, equal to, or more than about 0.000,5 wt %, 0.001, 0.005, 0.01, 0.05, 0.1, 0.5, 1, 2, 3, 4, 5, 6, 8, 10, 12, 14, 16, 18, 20, 22, 24, 26, 28, or about 30 wt % or more.

### Disconnecting the First and Second Component.

In various embodiments, the method can include disconnecting the first and second component. Disconnecting can include exposing the sacrificial material in the connector to at least one of heat and acid. Disconnecting the first and second component can include degrading the sacrificial material, softening the sacrificial material, or a combination thereof, such that the connector no longer mechanically connects or chemically adheres the first component to the second component.

Exposure of an adhesive connector to heat, acid, or a combination thereof can soften (e.g., make less hard, or melt) the connector, such that the adhesive force of the connector decreases. Exposure of the adhesive connector to heat, acid, or a combination thereof can cause degradation of the sacrificial material, such that the adhesive force of the connector decreases. As the adhesive force of the connector decreases, due to softening, degradation, or a combination thereof, the first and second component can be disconnected with little to no force.

Exposure of a mechanical connector to heat, acid, or a combination thereof can soften (e.g., make less hard, or melt) the connector, such that mechanical force holding the connector and the components together decrease. Exposure of the mechanical connector to heat, acid, or a combination thereof can cause degradation of the sacrificial material, such mechanical force holding the connector and the components decrease. As the mechanical force holding the connector and the components together decreases, due to softening, degradation, or a combination thereof, friction-fitting connections between a component and the connector, or mechanically interlocking connections between a component and the connector, can weaken or loosen such that the first and second component can be disconnected with little or no force.

The heating during disconnecting can include any suitable heating, such as about 50° C. to about 500° C., or about 110° C. to about 130° C., or less than about 200° C., 195, 190° C., or less than 180° C., or about 50° C. or less, or less than, equal to, or more than about 60° C., 70, 80, 90, 100, 105, 110, 115, 120, 125, 130, 135, 140, 145, 150, 155, 160, 165, 170, 175, 180, 185, 190, 195, 200, 210, 220, 230, 240, 250, 260, 280, 300, 325, 350, 375, 400, 450, or about 500° C. or more. The heating can occur for any suitable amount of time, such as less than 1 h, less than 50 minutes, 40, 35, 30, 25, or less than 20 minutes, such as about 1 second or less, or less than, equal to, or more than about 5 seconds, 10, 20, 30, 40, 50 second, 1 minute, 2, 3, 4, 5, 10, 15, 20, 25, 30, 35, 40, 45, 50, 55 minutes, 1 hour, 1.2, 1.4, 1.6, 1.8, 2, 3, 4, 5, 6, 7, 8, 9, 10, 15, 20 h, 1 day, 1.5, 2, 3, 4, 5, 6 days, 1 week, 2 weeks, or about 1 month or more.

The acid can come from any suitable source. The acid can be added to the connected first and second components, such as via immersion of the in an acidic solution, such that the sacrificial material is exposed to the acid. The acid can be generated from within the connector, such as via use of one or more acid generators, such as one or more photoacid generators or one or more thermolytic acid generators.

The disconnecting can include exposing an acid generator in the connector to conditions suitable for the acid generator to generate acid, such as suitable amounts of at least heat or light. For example, generating the acid using a photoacid generator can include exposing to suitable amounts of light. In some embodiments, the light can be UV light. The light can be light including 248 nm wavelength light (e.g., for IMPTB).

After or during softening, degradation, or a combination thereof, disconnecting can further include exposing the sacrificial material or a degraded product thereof to a vacuum, solvent, or a combination thereof. In various embodiments, after the disconnecting, the first component and the second component include substantially no sacrificial material or degradation product thereof. In some embodiments, a suitable solvent can be used to dissolve or wash away the degradation products of the sacrificial material. In some embodiments, the disconnecting includes exposing to no vacuum (e.g., using ambient pressure). The disconnecting can include exposing to a suitable vacuum, such as about 0.000,1 mm Hg to about 750 mm Hg, about 0.000,1 mm Hg to about 300 mm Hg, or about 20 mm Hg to about 30 mm Hg, or about 0.000,1 mm Hg or less, or less than, equal to, or more than about 0.001 mm Hg, 0.01, 0.1, 1, 2, 3, 4, 5, 6, 8, 10, 12, 14, 16, 18, 20, 22, 24, 26, 28, 30, 40, 50, 60, 70, 80, 90, 100, 150, 200, 250, 300, 350, 400, 450, 500, 550, 600, 650, 700, or about 750 mm Hg or more. The vacuum can be applied for any suitable amount of time, such as less than 1 h, less than 50 minutes, 40, 35, 30, 25, or less than 20 minutes, such as about 1 second or less, or less than, equal to, or more than about 5 seconds, 10, 20, 30, 40, 50 second, 1 minute, 2, 3, 4, 5, 10, 15, 20, 25, 30, 35, 40, 45, 50, 55 minutes, 1 hour, 1.2, 1.4, 1.6, 1.8, 2, 3, 4, 5, 6, 7, 8, 9, 10, 15, 20 h, 1 day, 1.5, 2, 3, 4, 5, 6 days, 1 week, 2 weeks, or about 1 month or more.

### Method of Disconnecting Components.

In various embodiments, the present invention provides a method of disconnecting components. The method of disconnecting components can include any aspect of any embodiments of the method of connecting components described herein, but does not require connecting the components during the method. For example, the method of disconnecting components can include obtaining or providing a first component and a second component connected via a connector including a sacrificial material. The method of disconnecting components can include exposing the sacrificial material to at least one of heat and acid sufficiently to degrade the sacrificial material, soften the sacrificial material, or a combination thereof, such that the connector no longer connects the first component to the second component.

The method of disconnecting components can include obtaining or providing a first component and a second component connected via a connector including a sacrificial material. The sacrificial material can be about 50 wt % to about 100 wt % of the connector. The sacrificial material can be or can include a polymer that is poly(ethylene carbonate), polypropylene carbonate), poly(lactic acid), or a combination thereof. The connector can be an adhesive, a sacrificial mechanical connector, or a combination thereof. The method can include exposing the sacrificial material to at least one of heat and acid sufficiently to degrade the sacrificial material, soften the sacrificial material, or a combination thereof, such that the connector no longer mechanically connects or chemically adheres the first component to the second component.

### Sacrificial Adhesive.

Various embodiments provide a sacrificial adhesive, such as any embodiment of a sacrificial adhesive described herein. For example, the sacrificial adhesive can include a sacrificial material including a polymer. The polymer can include a repeating unit including a substituted or unsubstituted (C₂-C₂₀)hydrocarbylene and at least one of carboxylate, carbonate, carbamate, thiocarbonate, and thiocarbamate. In some embodiments, the sacrificial material can include or can be poly(ethylene carbonate), poly(propylene carbonate), poly(lactic acid), or a combination thereof.

### Sacrificial Mechanical Connector.

Various embodiments provide a sacrificial mechanical connector, such as any embodiment of a sacrificial mechanical connector described herein. For example, the sacrificial mechanical connector can include a sacrificial material including a polymer. The polymer can include a repeating unit that includes a substituted or unsubstituted (C₂-C₂₀)hydrocarbylene and at least one of carboxylate, carbonate, carbamate, thiocarbonate, and thiocarbamate. In some embodiments, the sacrificial material can include or can be poly(ethylene carbonate), poly(propylene carbonate), poly(lactic acid), or a combination thereof.

### EXAMPLES

Various embodiments of the present invention can be better understood by reference to the following Examples which are offered by way of illustration. The present invention is not limited to the Examples given herein.

Purchased materials. The polymers with sacrificial potential were purchased from different retailers. The polyethylene carbonate (PEC) was purchased from Empower Materials, under the brand name QPAC 25®. Polypropylene carbonate (PPC, Mn ˜50,000) was sourced from Sigma Aldrich, USA. Polylactic acid (PLA) with the brand name Ingeo® Biopolymere 2003D was received from NatureWorks, LLC (Blair, Nebr.), and is recommended for extrusion by the manufacturer. Additional chemicals purchased were tin (II) oxalate (98 wt % purity, Sigma Aldrich USA), which was used as a catalyst for accelerated PLA decomposition. Solvents used to dissolve PPC were γ-butyrolactone, anisole, and acetone and were purchased from Sigma Aldrich (USA). The photoacid generator used in PPC decomposition studies was 4-Isopropyl-4′-methyldiphenyliodonium tetrakis(pentafluorophenyl)borate (referred as IMTPB in the following) and was received from TCI America. Furthermore light mineral oil was used as a binder between the PLA pellets and the tin (II) oxalate.

Weight loss test. A determination if specific polymers were eligible candidates to function as sacrificial fiber materials was desired. In order to screen selected polymers, the polymer weight loss caused by thermal decomposition was investigated. Samples were exposed to various temperatures for a controlled period of time in a vacuum oven, which is an appropriately simple and efficient method to screen materials and their decomposition potential. This test method will be referred to as the “weight loss test” in the following paragraphs.

The weight loss test was performed in a Fisher Scientific Isotemp™ 281A vacuum oven. Polymer specimens were placed within aluminum weighing pans (ID 42 mm and 67 mm, McMaster, USA). The specimens consist of untreated polymer pellets, treated polymer fibers, and solvent-cast films. Empty aluminum weigh pans were tested as control samples. In order to provide the most uniform oven temperature profile, specimens were placed only on the top rack in the oven. Similarly, the sample thermal gradient was minimized by not placing specimens directly in front of the window of the vacuum oven, where measurements indicate a lower temperature due to radiative heat loss. The oven temperatures reported were measured in the middle above the top rack. The oven was preheated to the designated temperature, then the samples were placed in the oven. Vacuum was applied with a vacuum pump (MaximaDry, Fisher Scientific) and once the maximum achievable vacuum was reached (approximately −97 kPa), the oven valve was sealed and the pump was turned off. At the conclusion of the desired heat exposure time, the heating elements were turned off and the oven was cooled while under vacuum; this process typically required a few hours, depending on the oven temperature.

All weighing of the samples was done with a Denver Instrument PI-214 analytical balance. Unless explicitly mentioned, no additional conditioning of the samples was performed before any weighing. The sample weight was typically was chosen to be in between 0.10 g and 0.20 g. Samples lighter than 0.10 g were not considered acceptable in order to reduce measurement errors, such as impurities or other small contamination of the samples like dust particles.

Preparing PPC with Photoacid Generator. The PAG 4-isopropyl-4′-methyldiphenyliodonium tetrakis(pentafluorophenyl)borate (IMTPB) purchased from TCI America. A 3.75 wt % PAG loading was used as the starting value. To blend the PAG into the PPC, PPC was dissolved in a compatible solvent and the PAG powder was subsequently added. Solutions were prepared by mixing PPC in a ratio of 1:3 and 1:5 with anisole, acetone, or γ-butyrolactone in glass scintillation vials. An attempt to use an ultrasonic bath to mix the ingredients was attempted for times of up to 7 h, but does not result in effective mixing (ice cubes were added occasionally to the bath to keep its temperature under 40° C.). All further mixing efforts were performed on a Fisher Scientific™ Isotemp™ stirring hotplate (Cat. No. 11-200-49SH) by using magnetic stir bars placed in the vials. IMTPB has the following chemical structure. Afterwards, PPC/PAG films were solvent cast by pouring the solutions into aluminum weighing pans. After several hours of evaporating the solvent at room temperature, the solutions were fully dried on the hot plate at 110-115° C. or in an oven at 45-50° C. (for specimens cast from γ-butyrolactone). The resulting polymer films possessed a thickness of about 0.2-0.3 mm.

PAG activation via UV-C light. To activate the PAG, specimens were cut from the solvent-cast PPC films and were exposed to UV light. Films with a thickness up to 50 μm were exposed to UV-C light of a wavelength of 248 nm with a minimum exposure dose of 1 J/cm². For thicker films, the exposure dose per cm² was proposed to be scaled accordingly. A UV-C light tube with 254 nm wavelength and 6 W power (Spectronics Corporation) was placed in a Spectroline EA-160 UV-Lamp casing. PPG/PAG-films were exposed by placing the samples in aluminum pans in a box covered with aluminum foil in the inside and top (assuming ideal conditions, aluminum reflects over 90% of incident short electromagnetic wavelength between 200-500 nm). To achieve an exposure dose of a minimum of 1 J/cm², the exposure time was chosen accordingly. For example, six specimen films with a thickness of about 0.3 mm and a surface area of each 1 cm² were exposed to UV-C light for at least 20 h. This results in a total exposure dose for each specimen of about 20 J. The thickness of 0.3 mm is six times the thickness of the previously mentioned 50 μm thick film. Thus, if the 20 J cumulative exposure is divided by 6 using a linear thickness scaling assumption, an equivalent exposure dose of about 3.3 J/cm² was given.

### Example 1

### Comparative. Polylactic Acid and Tin(II) Oxalate

Above 250° C., PLA polymer decomposes from its polymeric form into monomeric lactide, which is gaseous in form. Hence, the solid polymer evaporates at elevated temperatures to be easily evacuated from within structures over embedded paths exceeding one meter in length. When the PLA material contains tin (II) oxalate, the decomposition is catalyzed and the necessary temperature is reduced to near 200° C. This temperature is sufficiently low to minimize damage to composites containing epoxy resin matrices with a 350° F. (177° C.) cure cycle and which are common in the aerospace industry.

PLA with added tin (II) oxalate as a catalyst was extruded to produce fibers of different diameters. After drying the PLA pellets for at least 2 h at 90° C., the material was stored in a vacuum-sealed bag to prevent exposure to the humidity in the atmosphere. About 24 h before use, the dry PLA pellets were pre-coated with tin (II) oxalate powder by evenly coating the PLA pellets with 1 wt % mineral oil, then adding 3 wt % tin (II) oxalate powder into a container. All ingredients were mixed for several minutes with an IKA mixer (RW20 DS1) fitted with an auger blade.

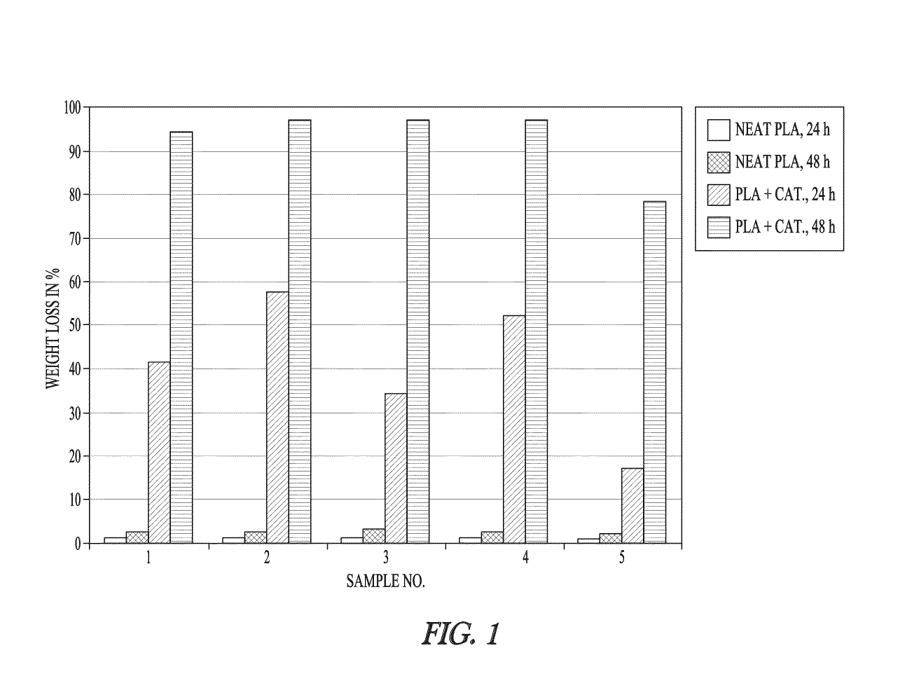

Neat PLA (2003D) fibers and PLA/tin (II) oxalate (3 wt %) fibers with a diameter approximately 0.3 to 0.5 mm were isothermally heated at 176° C. for a total of 48 h, with the sample weight measured also at 24 h. The initial sample weights ranged between 0.1 to 0.15 g. After 24 h, the neat PLA showed an average weight loss of 1.1 wt % (s=0.2 wt %), while the PLA mixed with 3 wt % tin (II) oxalate lost 40.7 wt % (s=16.0 wt %). After an additional 24 h, the total weight loss of neat PLA remained low and averaged 2.4 wt % (s=0.5 wt %), compared to 92.4 wt % average weight loss (s=7.7 wt %) for the PLA specimens mixed with tin (II) oxalate (see comparison in FIG. 1, illustrating PLA neat and with catalyst weight loss, 176° C., 24/48 h, −28.6″ Hg (726.4 mm), 4×5 samples). A fraction of the observed weight loss of few percent can be attributed to moisture loss, as the material was not dried in advance. Blending a catalyst in PLA may be necessary when it should be used as sacrificial material at temperatures not higher than 200° C. However, these results indicate the temperature required to fully and consistently decompose the matrix will exceed 177° C. (350° F.).

An additional nine samples of PLA/tin (II) oxalate fibers were tested at 194° C. for 24 h, resulting in an average weight loss of 98.2 wt % (s=0.5%). At the higher temperature of 201° C., no additional weight loss benefit was achieved.

Samples of twin screw extruded PLA 2003D with 3 wt % tin (II) oxalate and PLA 6201D with 3 wt % tin (II) oxalate were heated to 198° C. for 24 h and showed a weight loss of 97.4 wt % (s=0.0%) each. This impressive reduction in variability for the twin screw blended material indicates that inhomogeneity due to poor dispersion decreases decomposition quality. Overall, it was discovered that, when decomposing the different PLA/tin (II) oxalate samples in a temperature range of 194° C.-201° C., the standard deviation of the average weight loss is minimized to the range of 0-0.5 wt %.

The residual ˜3 wt % mass closely corresponds to the 3 wt % of tin (II) oxalate that was blended into the PLA fibers. Thus, it is believed that the polymeric material was fully decomposed. Any discrepancy between the observed residual mass and the initial 3 wt % loading fraction was likely due to a combination of measurement accuracy and because some of the tin (II) oxalate powder coating on the PLA pellets fell off while it was processed. The amount of lost catalyst can vary depending on the exact processing steps utilized; powder residue was observed on the beaker and auger during the mechanical mixing step, in the plastic storage bag used for transport, and on the surfaces of the hopper of the extruder).

### Example 2

### Poly(ethylene Carbonate)

A weight loss test was performed to characterize PEC's decomposition. Nine aluminum weighing pans, containing the samples, were placed on each of the two racks at the top and bottom of the vacuum oven. The oven was set to 181° C., and the sample weight was measured after 24 h and 48 h.

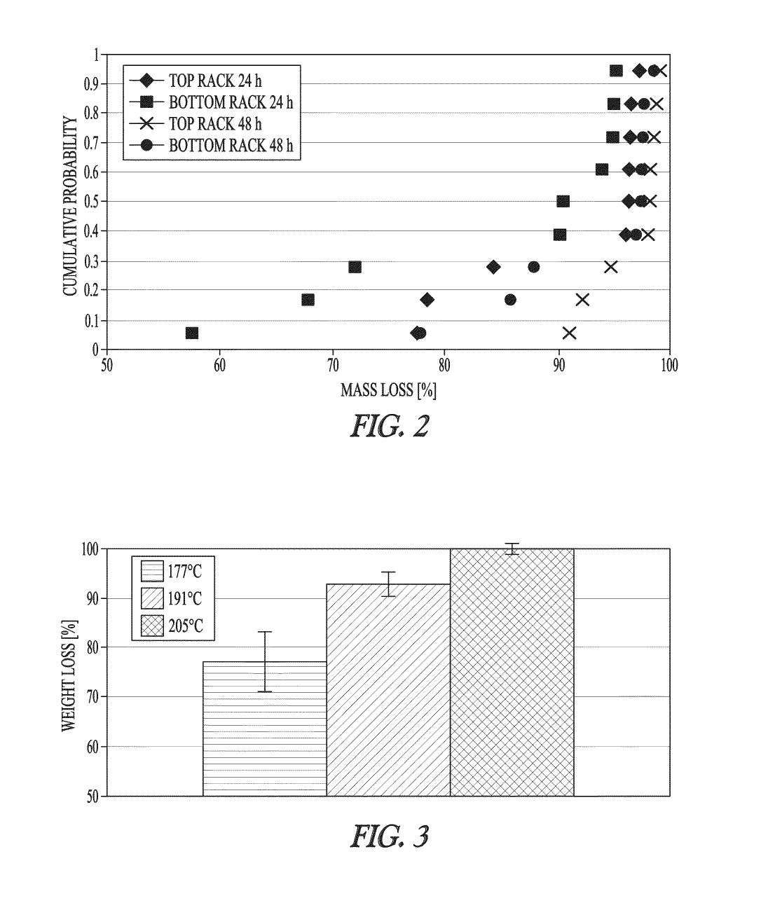

The results of the weight loss are plotted in FIG. 2, which graphs the cumulative probability as a function of mass loss, illustrating PEC weight loss as a function of rack position within the vacuum oven. The data are recorded for 181° C. decomposition at 24 and 48 h under −28.6″ Hg (726.4 mm). The data show trends in the sample weight loss; the trends are especially apparent for the data recorded after 24 h of thermal treatment. As can be seen, there were three specimens on both the top and bottom racks which demonstrate a significantly lower degree of mass loss as compared to the other samples. The samples for which the lowest weight loss was measured were situated on the bottom rack near to the front oven window. That indicates that the temperature distribution in the oven has a temperature gradient sufficient to influence the decomposition behavior of PEC decomposition. Considering the exponential dependence of thermal decomposition processes on temperature, it is likely that all other tested materials will be similarly affected by this temperature gradient. Hence, subsequent tests were restricted to specimens located on the top rack near the back of the vacuum oven.

The data analysis of the mass loss was restricted to the 6 samples placed on the top rack in the rear, promising decomposition results are summarized in Table 1. Despite the mass loss of greater than 96% with a small standard deviation for the first 24 h run, the specimens lost only an additional 2 wt % in the second 24 h period.

TABLE 1
PEC Weight loss for 6 samples on top rack at over rear, 24 and 48 h
cycles at 181° C.

| | 24 h [wt %] | 48 h [wt %] |
|---|---|---|
| Average weight loss | 96.4 | 98.4 |
| Standard deviation | 0.4 | 0.4 |
| Minimum value | 97.2 | 98.0 |
| Maximum value | 96.0 | 99.0 |

A further weight loss test at 159° C. was performed for 64 h (vacuum −28.4″ Hg (721.4 mm)) to investigate the weight loss potential of PEC at a significant lower temperature. The average specimen weight loss was 85.3% (standard deviation s=5.0%, minima 76.7%, maxima 91.5%). Testing the weight loss again at 177° C. for 24 h, an average mass loss of 79.7% (s=5.3%) was achieved.

### Example 3

### Poly(propylene Carbonate)

PPC was first isothermally tested at 191° C. for 25 h. Six tested specimens showed an average weight loss of 92.2% (s=2.3%) which was promising but insufficient for reliable sacrificial processing. An increase in the oven temperature to 205° C. increased the weight loss to 100.1% (s=0.7%) after a testing period of 24 h. Therefore, PPC possesses the basic properties necessary for a sacrificial material, but it decomposition temperature still was high relative to the degradation temperatures of typical composites epoxy matrices. For that reason, an approach that mixes photoacid generator (PAG) into the PPC was pursued to attain a catalytic decomposition reaction of the polymer in order to lower the decomposition temperature (Examples 4 and 5).

A comparison of the decomposition of PPC at temperatures of 177° C., 191° C., and 205° C. for 24 h in FIG. 3 indicates a significant decrease in the standard deviation of the isothermal weight loss from 6.2%, to 2.3%, and subsequently to 0.7% as the temperature increases. FIG. 3 illustrates PPC weight loss and standard deviation at 177° C., 191° C., and 205° C. (error bars denote standard deviation). The standard deviation decreased with increasing heat exposure time. This effect was expected and generally observed with the other tested materials. One explanation regards the fact that the tested specimens were granules with a distribution to their geometry and dimension. Larger particles require more time to decompose, because, there is more mass to decompose and they possess a smaller surface to mass ratio. Furthermore, the relative temperature gradient, which affects the relative sample decomposition between sample pans, is minimized for increased temperatures.

### Example 4

### Poly(propylene Carbonate) with Photoacid Generator (PAG)

PPC specimens with PAG homogeneously incorporated into the matrix where produced by solvent casting as described in the paragraph above “Preparing PPC with Photoacid Generator.” PPC/(anisole and PAG) (boiling point anisole 154° C.) and PPC/(acetone and PAG) (boiling point acetone 56-57° C.) solutions were mixed in a weight ratio of 1:3 and 1:5; empirical results demonstrated that blending the ingredients was more easily accomplished with the higher the PPC/solvent ratio of 1:5 so as to ensure that all PPC was dissolved. Although it was possible to prepare the solution with the lower ratio, significantly longer time and more stirring effort was required to create a homogeneous polymer solution. The solution was poured into an aluminum weighing pan and the solvent evaporated at room temperature and on a hot plate. It was observed that the solvent cast films were more easily detached from the aluminum pan after the “soft baking” process on the hot plate.

Two solvents, γ-butyrolactone (boiling point 204-205° C.) and acetone, were tested to determine their suitability for solvent casting of PPC mixed with PAG. γ-butyrolactone was used to prepare PPC/γ-butyrolactone(/PAG) solution. To avoid premature activation of the PAG, evaporation of the γ-butyrolactone of the solvent cast films was performed by heating them at 45-50° C. in an oven. After 80 h, no additional significant weight loss was measured. By contrast, the acetone easily evaporated at room temperature and heating the solution was unnecessary. Nevertheless, a short soft baking process of the solvent cast film is recommended to ensure that all the acetone is evaporated. Hence, acetone is preferable to γ-butyrolactone from a processing perspective.

When exposing the solvent cast PPC films, loaded with 3.75 wt % PAG, to UV-C light, its color became slightly brown. Neat PPC granulates similarly exposed to UV-C light under the same conditions (19 h, 6 W, 254 nm) also became slightly brownish. This result indicated that the change of color is not necessarily induced by the PAG, but rather a UV-induced degradation mechanism.

The weight loss at 175° C. over 19 h of the anisole cast films did not showed an improved weight loss performance compared to the acetone cast films, as can be seen in Table 2. Nor was there an observed improvement attributable to UV-activation of the PAG. As shown in Example 5 via TGA, UV-C activation of the PAG does impact the needed decomposition time of the PPC/PAG system.

TABLE 2
Weight loss comparison after isothermal decomposition at 175° C. of
PAG-loaded PPC films cast from acetone and anisole.

| | Average weight loss | Standard deviation |
|---|---|---|
| Acetone cast, no UV-C | 97.3% | 0.4% |
| Anisole cast, no UV-C | 98.2% | 0.7% |
| Acetone cast, with UV-C | 97.5% | 0.4% |
| Anisole cast, with UV-C | 97.5% | 0.4% |

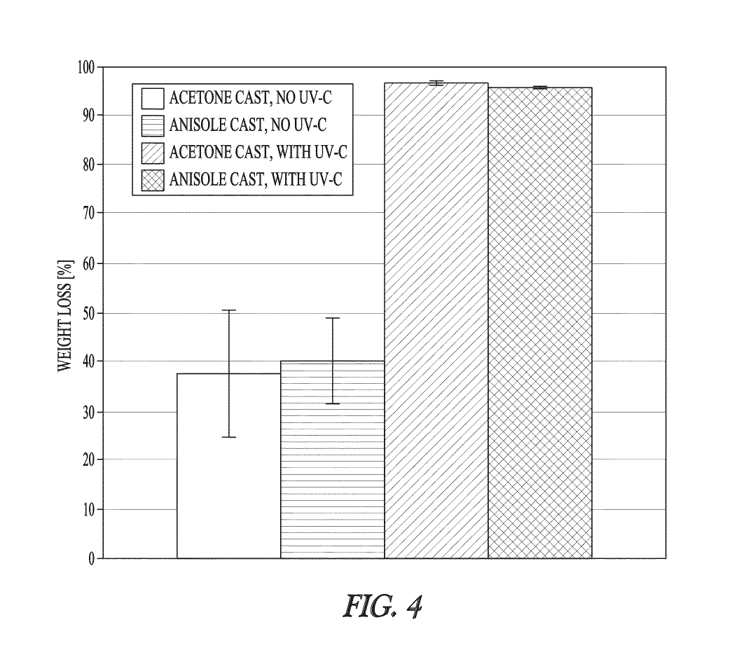

Heating unexposed anisole and acetone cast PPC/PAG specimens for 24 h at 125° C., an average weight loss as low as 20.5% (s=3.6%) for anisole cast and an average of 17.3% (s=4.0%) was measured. Subsequently, the same material was tested with same parameters, but this time with unexposed and exposed films. The results are visualized in FIG. 4, illustrating PPC/PAG (3.75 wt %) specimens isothermally held at 125° C. for 24 h under −29″ Hg (736.6 mm) of vacuum (error bars denote standard deviation). FIG. 4 indicates that at decomposition temperatures low as 125° C., samples exposed to UV-C light dramatically enhances their decomposition rate. The anisole cast PPC/PAG samples showed an average weight loss of 95.8% (s=0.3%) compared to the acetone cast PPC/PAG samples with 96.1% (s=0.5%). Thus, again no statistically significant effect of solvent choice was found. The higher average weight loss (38-40%) of the unexposed specimens in the run, compared to the result presented at the beginning of this paragraph (20.5%), was due to the placement of the samples. The unexposed samples in FIG. 4 were placed on the rack closer to the side sections of the oven, where it was warmer, compared to specimens placed in the middle of the rack.

PPC samples with 3.75 wt % and 5.00 wt % loading, UV-C exposed and unexposed were tested to investigate the effect of different PAG loadings. The results can be seen in FIG. 5, illustrating PPC mixed with 3.75 and 5.00 wt % PAG loading, unexposed and exposed to UV-C light, γ-butyrolactone dissolved, isothermal heating for 24 h at 125° C. under vacuum (error bars denote standard deviation). The maximum average weight loss of 96.8% (s=0.4%) was achieved with the lower 3.75 wt % PAG loading. The higher PAG loaded samples had an average weight loss of 95.1 wt % (s=0.5%). The left-over mass was in each case closely matched to the percentage of the PAG loading, what indicates that the residual mass was fully composed of the PAG.

A black colored residue was observed in the aluminum pans after isothermal heating. This residue was quickly dissolved when it was rinsed with acetone. The residue was also soluble in ethanol, though its dissolution rate was slower relative to acetone. The residue was not soluble in water.

### Example 5

### Thermogravimetric Analysis

The thermal decomposition behavior can be more continuously and precisely measured via thermogravimetric analysis. Via TGA, the mass loss of materials can be measured as a function of time under isothermal conditions or as a function of temperature using a defined heating rate. TGA was performed with a TA Instruments TGA 2950 HR. The tested specimens possessed an initial weight of approximately 10 mg and their mass loss was measured under isothermal conditions at temperatures of 121° C., 177° C., and 200° C. (for PLA/tin (II) oxalate) in a nitrogen atmosphere.

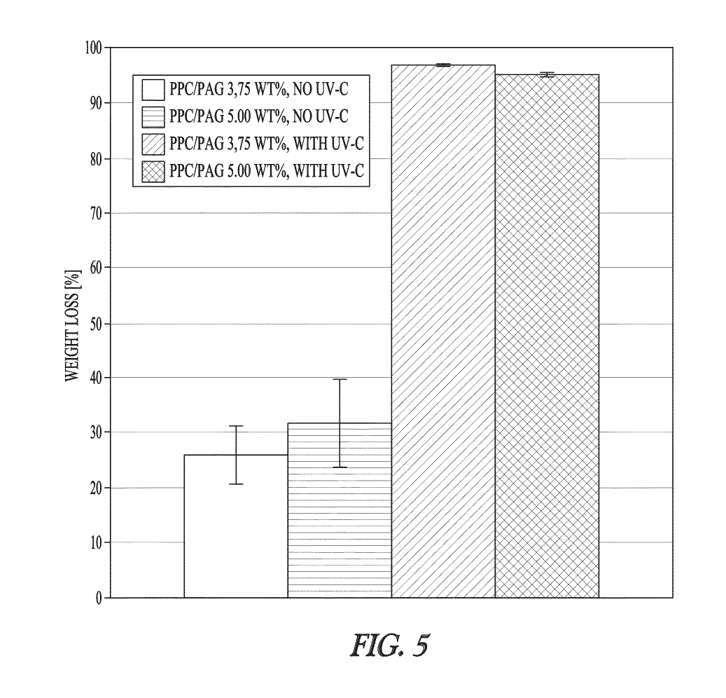

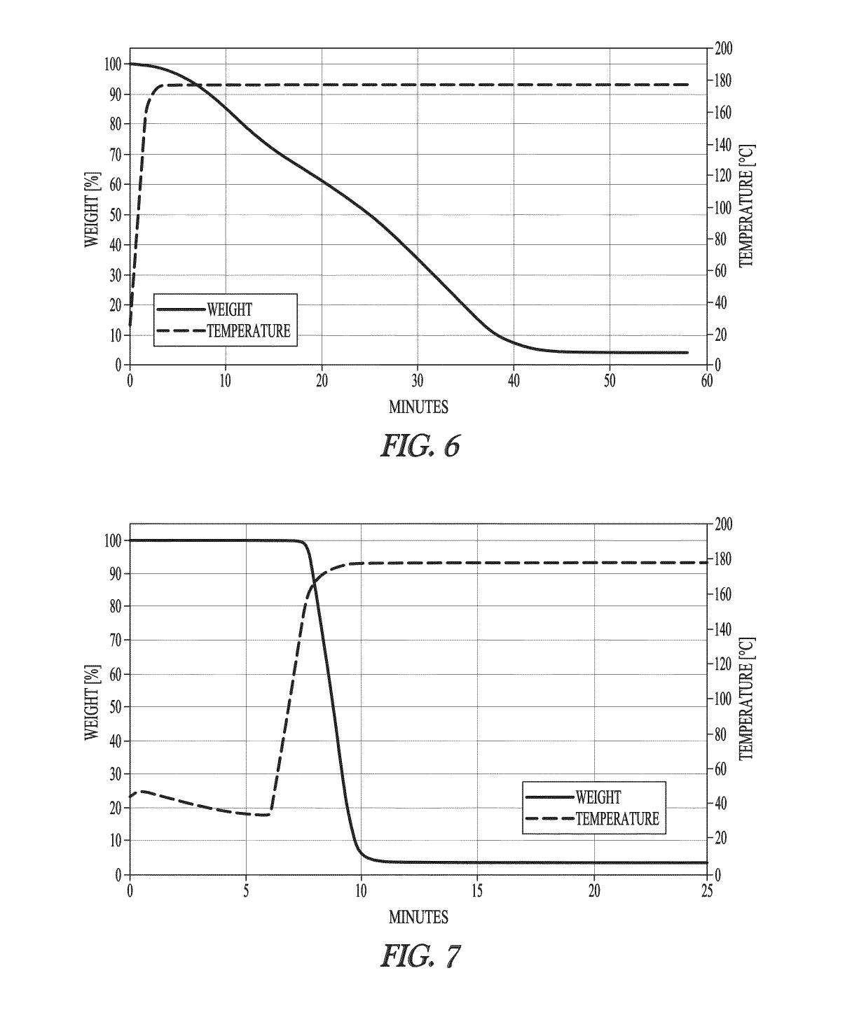

The masses of PPC/PAG specimens were tested by isothermal TGA to determine the effects of UV exposure and inclusion of the photoacid generator (PAG). The mass loss of a PPC specimen containing 3.75 wt % PAG, but not exposed to UV radiation, was shown in FIG. 6, illustrating a TGA test at 177° C. (N₂ atmosphere) for PPC with PAG (3.75 wt %) and no UV-C exposure. FIG. 6 illustrates that at 177° C. (350° F.) with no UV-C exposure the material is gone within an hour. The temperature reached equilibrium at 177° C. in approximately 4 min. The mass of the specimen was relatively rapid and decomposes 95 wt % of the specimen within 45 min. The mass loss plateaued after that point, resulting in a 4.1 wt % residual mass after approximately 55 min of heat exposure.

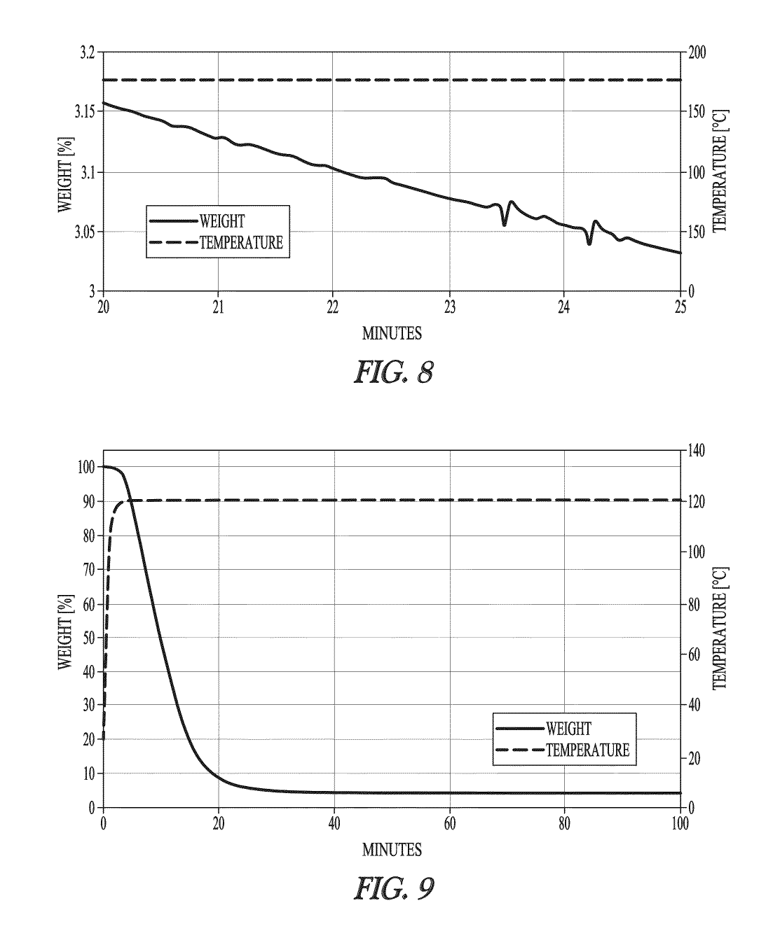

In order to determine the improvement observed after exposure to UV-C radiation, a second sample was prepared and exposure to UV light. A first TGA run with an exposed PPC/PAG sample, starting heating and N₂ purging at the same time, resulted in a fluctuating and increasing measured sample mass up to 150 wt %, falling down to 2 wt % after 2 min. That might have been caused by an oxidative reaction due to remaining oxygen in the testing chamber. For that reason, for the next run the test chamber of the TGA was first purged with N₂ for about 6 min to avoid oxidation reactions of the sample (FIG. 7, illustrating a TGA test at 177° C. (N₂ atmosphere) for PPC with PAG (3.75 wt %) and with UV-C exposure). FIG. 7 illustrates that at 177° C. with UV-C exposure the material is gone within 10 minutes. A weight loss of 97.0% was achieved after about 18 min of heat exposure. Starting with 100% initial mass, it takes about 42 min for the unexposed PPC/PAG system to reach 5 wt % initial mass compared to just 2.5 min for the exposed PPC/PAG system to reach the same 5 wt % threshold, a factor of 16.8 times faster in terms of decomposition speed. This indicates that also the unexposed PAG was catalyzing the PPC decomposition. The thermally induced generation of acid, however, takes time and thus the sample with the photo-generated acid dramatically accelerates the decomposition. When a detailed view of the plateau region of FIG. 8 is considered, it is clearly seen that there still is a linear weight loss of approximately 0.025 wt % min⁻¹ in the exposed PPC/PAG system. FIG. 8 illustrates the detail of the TGA test at 177° C. (N₂ atmosphere) for PPC with PAG (3.75 wt %) and with UV-C exposure. An extrapolation of this linear decomposition rate results in a calculation that complete decomposition of the residual polymer will be achieved after a further 120 min.

The results at 177° C. clearly indicate PPC loaded with PAG can be quickly and cleanly decomposed. In order to determine if the material system was suitable for 121° C. (250° F.) matrix cure cycles, additional specimens were characterized at this lower temperature. The TGA results for a PPC and 3.75 wt % PAG specimen exposed to UV-C is shown in FIG. 9, illustrating a TGA test at 121° C. (N₂ atmosphere) for PPC with PAG (3.75 wt %) and with UV-C exposure, showing that with UV-C exposure the material is gone within ˜30 minutes. After 100 min of isothermal heating at 121° C., a residual sample mass of 4.2 wt % remains. The threshold of 5 wt % of the initial mass was reached after 28 min; while this was 11.2 times slower than the same material tested at 177° C., it was 50% faster than the time required for the specimen not exposed to UV needs to reach the 5 wt % level. The best performance was achieved under UV-C exposure at the higher temperature of 177° C.

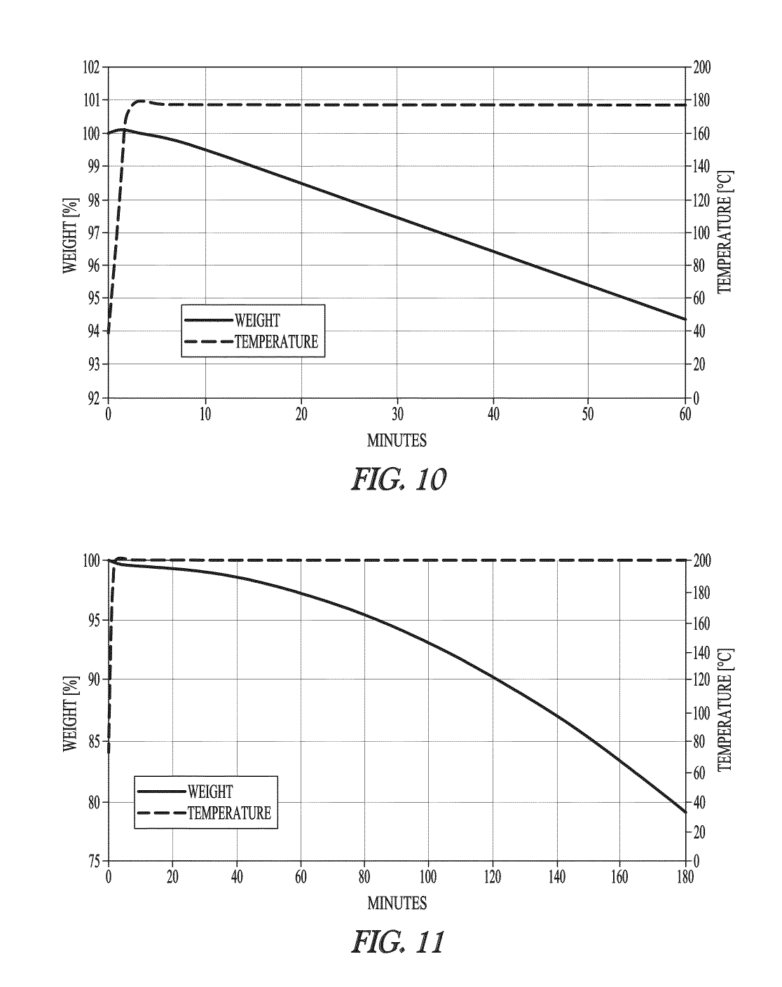

The mass loss of the photoacid generator, IMTBP, was measured at 177° C. for 60 min. After a 10 min heating time, the decomposition rate was linear and amounts to 0.10 wt % min⁻¹. Assuming that the decomposition rate remains linear, the complete decomposition of the IMTBP was extrapolated to require 16.7 h. Even though the IMTBP was tested in neat and unactivated conditions (e.g., no UV-C exposure), thermolytic activation of the PAG was expected at the 177° C. test temperature, as observed in PPC/PAG specimens that were catalytic decomposed at similar temperatures without preceding UV-C exposure (Table 2). FIG. 10 illustrates a TGA test at 177° C. (N₂ atmosphere) for IMTBP (PAG) and no UV-C exposure.

To investigate the twin screw compounded PLA and catalyst system, thermogravimetric analysis was also performed on PLA fibers extruded with 3 wt % tin (II) oxalate. FIG. 11, illustrating a TGA test at 200° C. (N₂ atmosphere) for PLA with 3 wt % tin (II) oxalate, twin screw compounded, shows that after 120 min at 200° C. a mass loss of 9.7% was reached. Though the curve may exhibit a continued acceleration in the decomposition rate, a regression of the approximately linear curve between 160 and 180 min is 0.21 wt % min⁻¹.

### Example 6

### Fused Deposition Modeling of PLA

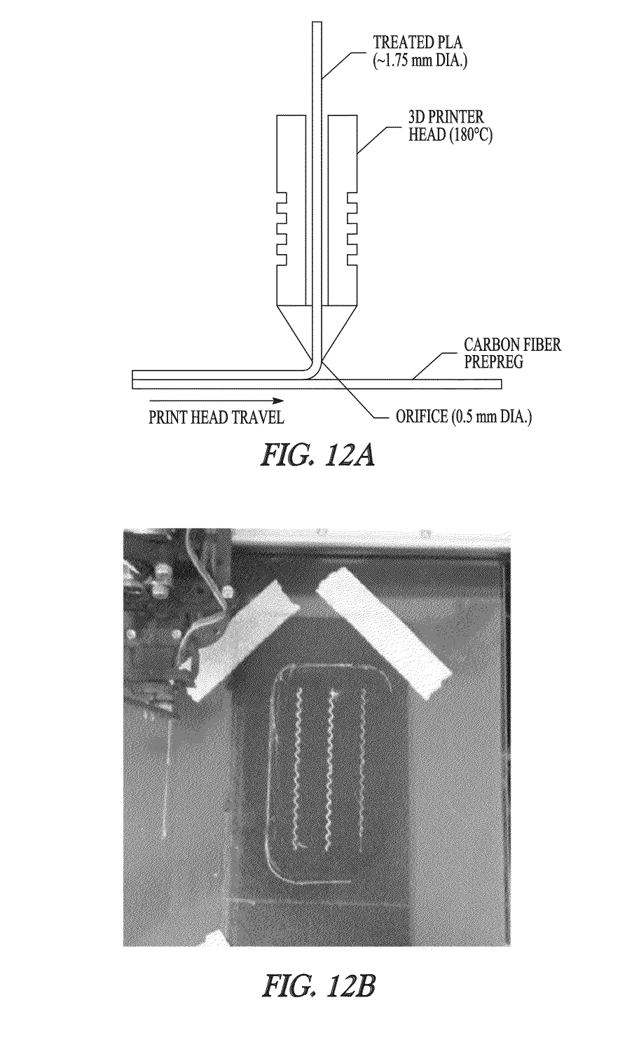

Fused deposition modeling (FDM), in which a thermoplastic filament is printed in a molten state onto a substrate, was investigated. The procedure used a 1.75 mm sacrificial PLA filament as the printed material (from Example 1, including 3 wt % tin(II) oxalate, which was then precisely patterned onto various composite materials. The FDM printer successfully fed the sacrificial filament from the spool into the print head using two feed rollers. There, the sacrificial PLA filament was heated to 180° C. to melt the PLA, which then exits through the 0.5 mm diameter print head orifice. FIG. 12A illustrates the sacrificial PLA filament being fed into the print head, heated to molten state at 180° C., and extruded in an X-Y pattern on a (“carbon fiber prepreg”). FIG. 12B is a reproduced photograph of the printed PLA, with the composite material taped in the three-dimensional printer.

### Example 7

### PLA Joints

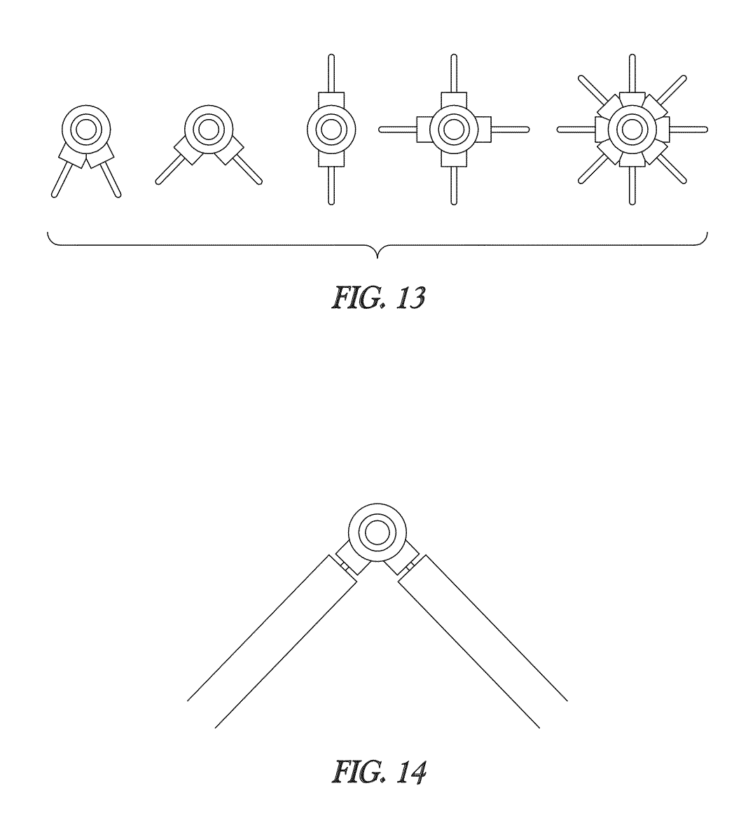

Using 1.75 mm PLA fiber from Example 1 (including 3 wt % tin oxalate), using the three-dimensional printing process of Example 6, joints (e.g., fasteners) having 2, 4, or 8 connections were printed. A photograph of the joints is reproduced in FIG. 13.

A simple two-strut joint strut was created by inserting a planar joint having two connections into a central bore within the struts. A photograph of the two-strut joint is reproduced in FIG. 14.

### Example 8

### Jointing of Plates using Sacrificial Adhesive

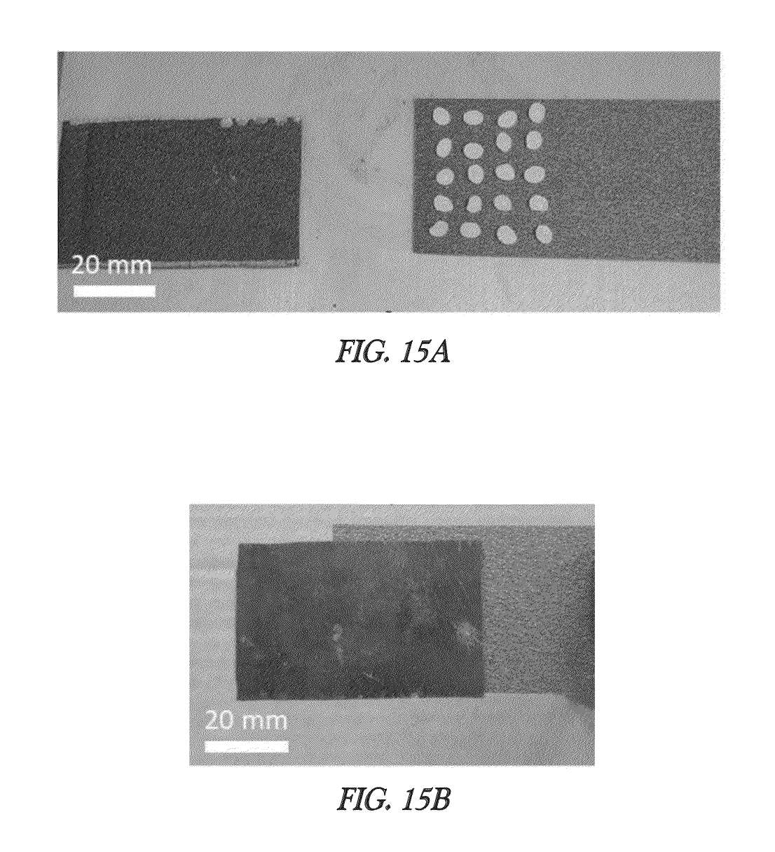

Pellets of PLA coated in tin (II) oxalate catalyst from Example 1 were placed on top of a carbon fiber-epoxy matrix composite plate (“carbon fiber prepreg,” which had previously been cured in an autoclave). This plate was then heated to about 180° C., which softened the PLA material such that it could flow. A second composite plate was then compressed against the plate and PLA adhesive. The two plates and bond adhesive were cooled while compressed to solidify the bond area. A photograph of the plates is reproduced in FIG. 15A showing the plates before bonding, and in FIG. 15B showing the plates after bonding.

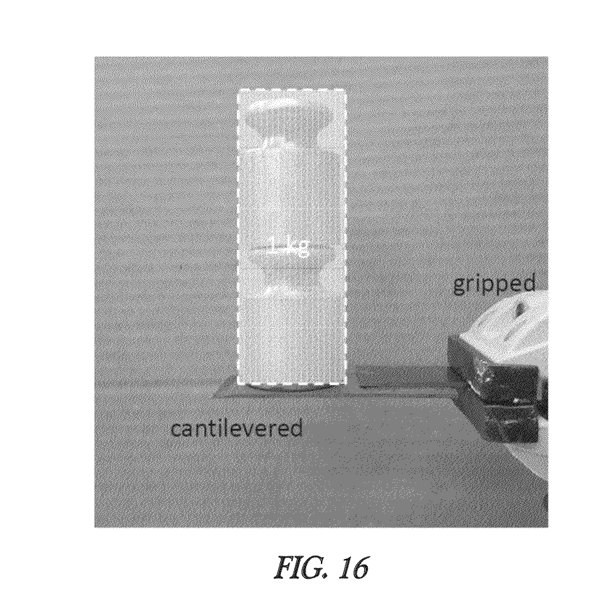

To test the normal bonding tensile strength, one plate was gripped and the second plate cantilevered out. Weights were placed on the cantilevered beam to demonstrate the bond sustained mechanical loads. A photograph of the apparatus is reproduced in FIG. 16. The bond had a tensile strength of at least 1 kg per 1600 mm², or about 0.63 g/mm².

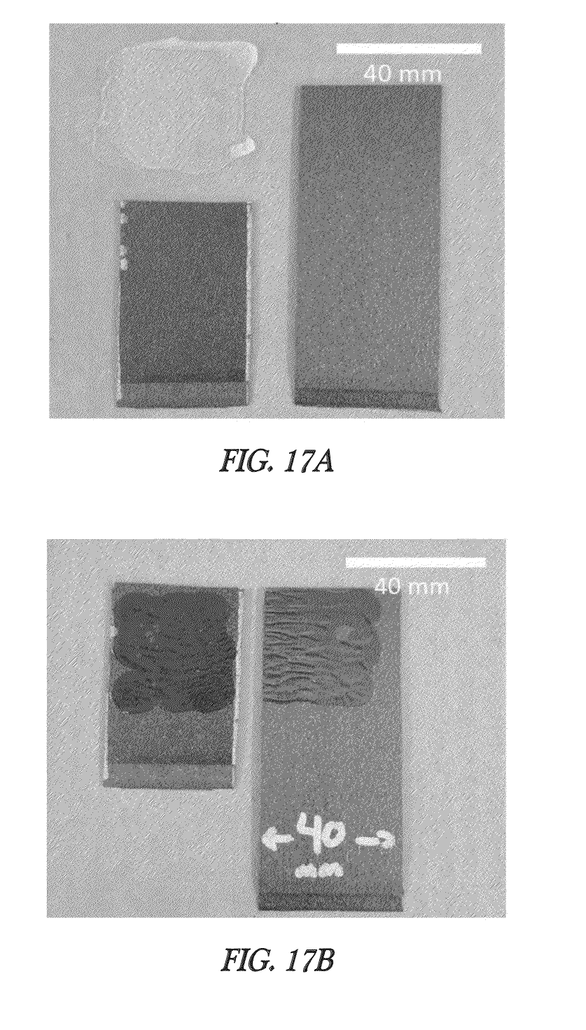

The plates were mechanically separated. A photograph of the plates and the adhesive after mechanical separation is shown in FIG. 17A. The experiment was repeated using different plates and adhesive, and the plates were heated to about 200° C., which caused the plates to separate easily from one another. A photograph of the plates and the adhesive after separation via heating is shown in FIG. 17B.

Further heating removed the adhesive due to the depolymerization of the polymeric bonding material to gaseous materials, leaving behind a thin dusting of catalyst that was easily brushed from the surface.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of forming a cavitated material, the method comprising:

forming a precursor composite material comprising a sacrificial fiber in a curable composition, wherein the sacrificial fiber comprises a polymer comprising a repeating unit comprising a substituted or unsubstituted (C₂-C₂₀)hydrocarbylene and at least one of carbonate, carbamate, thiocarbonate, and thiocarbamate;

curing the precursor composite material, to form a composite material;

exposing the composite material to at least one of heat and acid, such that at least some of the sacrificial fibers degrade; and

removing at least some of the degraded fibers, to form a cavitated material.

Embodiment 2 provides the method of Embodiment 1, wherein forming the precursor composite material comprises arranging the sacrificial fiber in the curable composition.

Embodiment 3 provides the method of Embodiment 2, wherein the arranging comprises arranging in a pre-determined or random pattern.

Embodiment 4 provides the method of any one of Embodiments 1-3, wherein the forming comprises at least one of extruding, spinning, and printing.

Embodiment 5 provides the method of any one of Embodiments 1-4, wherein the fibers have a diameter of about 0.001 μm to about 5 mm.

Embodiment 6 provides the method of any one of Embodiments 1-5, wherein the fibers have a diameter of about 50 μm to about 1 mm.

Embodiment 7 provides the method of any one of Embodiments 1-6, wherein the polymer comprises a repeating unit that is a (C₂-C₂₀)hydrocarbylene carbonate, wherein the (C₁-C₂₀)hydrocarbylene is substituted or unsubstituted.

Embodiment 8 provides the method of any one of Embodiments 1-7, wherein the polymer comprises a repeating unit that is a (C₂-C₅)hydrocarbylene carbonate.

Embodiment 9 provides the method of any one of Embodiments 1-8, wherein the polymer comprises a repeating unit that is ethylene carbonate or propylene carbonate.

Embodiment 10 provides the method of any one of Embodiments 1-9, wherein the polymer is poly(ethylene carbonate) or polypropylene carbonate).

Embodiment 11 provides the method of any one of Embodiments 1-10, wherein the sacrificial fibers are about 0.000,1 wt % to about 90 wt % of the precursor composite material.

Embodiment 12 provides the method of any one of Embodiments 1-11, wherein the sacrificial fibers are about 0.1 wt % to about 20 wt % of the precursor composite material.

Embodiment 13 provides the method of any one of Embodiments 1-12, wherein the curable composition comprises at least one of a thermoset composition, a thermoplastic composition, a polymerizable composition, and a crosslinkable composition.

Embodiment 14 provides the method of any one of Embodiments 1-13, wherein subjecting the composite material to acid comprises generating acid.

Embodiment 15 provides the method of any one of Embodiments 1-14, wherein the precursor composite material further comprises an acid generator, wherein subjecting the composite material to acid comprises generating acid from the acid generator.

Embodiment 16 provides the method of Embodiment 15, wherein the acid generator comprises a photoacid generator, wherein the generating the acid comprises exposing the acid generator to light such that the acid is formed.

Embodiment 17 provides the method of Embodiment 16, wherein the photoacid generator is about 0.001 wt % to about 30 wt % of the precursor composite material.

Embodiment 18 provides the method of any one of Embodiments 16-17, wherein the photoacid generator is about 0.1 wt % to about 5 wt % of the precursor composite material.

Embodiment 19 provides the method of any one of Embodiments 16-18, wherein the photoacid generator comprises at least one of bis(4-tert-butylphenyl)iodonium perfluoro-1-butanesulfonate, bis(4-tert-butylphenyl)iodonium p-toluenesulfonate, bis(4-tert-butylphenyl)iodonium triflate, boc-methoxyphenyldiphenylsulfonium triflate, (4-bromophenyl)diphenylsulfonium triflate, (tert-butoxycarbonylmethoxynaphthyl)-diphenylsulfonium triflate, (4-tert-butylphenyl)diphenylsulfonium triflate, diphenyliodonium, diphenyliodonium nitrate, diphenyliodonium perfluoro-1-butanesulfonate, diphenyliodonium p-toluenesulfonate, diphenyliodonium triflate, (4-fluorophenyl)diphenylsulfonium triflate, N-hydroxynaphthalimide triflate, N-hydroxy-5-norbornene-2,3-dicarboximide perfluoro-1-butanesulfonate, (4-iodophenyl)diphenylsulfonium triflate, (4-methoxyphenyl)diphenylsulfonium triflate, 2-(4-methoxystyryl)-4,6-bis(trichloromethyl)-1,3,5-triazine, (4-methylphenyl)diphenylsulfonium triflate, (4-methylthiophenyl)methyl phenyl sulfonium triflate, (4-phenoxyphenyl)diphenylsulfonium triflate, (4-phenylthiophenyl)diphenylsulfonium triflate, triarylsulfonium hexafluorophosphate, triphenylsulfonium perfluoro-1-butanesufonate, triphenylsulfonium triflate, tris(4-tert-butylphenyl)sulfonium perfluoro-1-butanesulfonate, and tris(4-tert-butylphenyl)sulfonium triflate.

Embodiment 20 provides the method of any one of Embodiments 16-19, wherein the acid generator is 4-isopropyl-4′-methyldiphenyliodonium tetrakis(pentafluorophenyl)borate.

Embodiment 21 provides the method of any one of Embodiments 16-20, wherein the generating the acid comprises exposing the acid generator to light comprising about 248 nm wavelength.

Embodiment 22 provides the method of any one of Embodiments 1-21, wherein the removing comprises exposing the composite material to vacuum and heat such that at least some of the degraded fibers are removed from the composite.

Embodiment 23 provides the method of any one of Embodiments 1-22, wherein the removing comprises exposing the composite material to a vacuum of about 0.000,1 mm Hg to about 750 mm Hg.

Embodiment 24 provides the method of any one of Embodiments 1-23, wherein the removing comprises exposing the composite material to about 50° C. to about 500° C.

Embodiment 25 provides the method of any one of Embodiments 1-24, wherein the removing comprises exposing the composite material to about 110° C. to about 130° C.

Embodiment 26 provides the method of any one of Embodiments 1-25, wherein the removing comprises exposing the composite material to about 110° C. to about 130° C. for about 20 minutes to about 1 hour.

Embodiment 27 provides the cavitated material formed by the method of any one of Embodiments 1-26.

Embodiment 28 provides a method of forming a cavitated material, the method comprising:

forming a precursor composite material comprising a sacrificial fiber and a photoacid generator in a curable composition, wherein the sacrificial fiber comprises a polymer comprising at least one of poly(ethylene carbonate) and poly(propylene carbonate);

curing the precursor composite material, to form a composite material;

exposing the photoacid generator to light such that the photoacid generator generates acid and at least some of the fibers degrade; and

exposing the composite to heat and vacuum such that at least some of the degraded fibers are removed from the composite, to form a cavitated material.

Embodiment 29 provides a cavitated material formed by a method comprising:

forming a precursor composite material comprising a sacrificial fiber in a curable composition, wherein the sacrificial fiber comprises a polymer comprising a repeating unit comprising a substituted or unsubstituted (C₂-C₂₀)hydrocarbylene and at least one of carbonate, carbamate, thiocarbonate, and thiocarbamate;

curing the precursor composite material, to form a composite material;

exposing the composite material to at least one of heat and acid, such that at least some of the sacrificial fibers degrade; and

removing at least some of the degraded fibers, to form a cavitated material.

Embodiment 30 provides a method of connecting components, the method comprising:

connecting a first component and a second component via a connector comprising a sacrificial material.

Embodiment 31 provides the method of Embodiment 30, wherein the connector is an adhesive material, a mechanical connecting component, or a combination thereof.

Embodiment 32 provides the method of any one of Embodiments 30-31, wherein the sacrificial material is about 0.001 wt % to about 100 wt % of the connector.

Embodiment 33 provides the method of any one of Embodiments 30-32, wherein the sacrificial material is about 50 wt % to about 100 wt % of the connector.

Embodiment 34 provides the method of any one of Embodiments 30-33, wherein connecting comprises adhering the first component to the second component with the connector.

Embodiment 35 provides the method of Embodiment 34, further comprising applying the connector to the first or second component before connecting the first component to the second component via the connector.

Embodiment 36 provides the method of Embodiment 35, wherein applying the connector to the first or second component comprises placing, spraying, brushing, coating, dipping, pouring, dripping, melting, extruding, printing, or a combination thereof.

Embodiment 37 provides the method of any one of Embodiments 30-36, comprising heating the sacrificial material prior to connecting the first and second component.

Embodiment 38 provides the method of Embodiment 37, wherein the heating comprises melting or softening.

Embodiment 39 provides the method of any one of Embodiments 34-38, wherein connecting comprises adhering the first component to the second component with the connector such that the first component is bonded to the second component with a tensile strength of about 0.01 g/mm² to about 100,000 g/mm².

Embodiment 40 provides the method of any one of Embodiments 34-39, wherein connecting comprises adhering the first component to the second component with the connector such that the first component is bonded to the second component with a tensile strength of about 0.4 g/mm to about 0.8 g/mm².

Embodiment 41 provides the method of any one of Embodiments 30-40, wherein connecting comprises mechanically attaching the first component to the second component via the connector.

Embodiment 42 provides the method of Embodiment 41, wherein the connector is a sacrificial fastener.

Embodiment 43 provides the method of Embodiment 42, wherein the sacrificial fastener is a nail, bolt, nut, screw, clip, clamp, clasp, latch, dowel, biscuit, staple, cable, strap, thread, tie, pin, peg, hook and loop fastener, rivet, zipper, wedge anchor, or a combination thereof

Embodiment 44 provides the method of any one of Embodiments 42-43, wherein the sacrificial fastener comprises one or more connecting rods extending therefrom.

Embodiment 45 provides the method of Embodiment 44, wherein the one or more connecting rods extend from a central component of the fastener.

Embodiment 46 provides the method of any one of Embodiments 44-45, wherein at least one connecting rod comprises the sacrificial material, the central component of the fastener comprises the sacrificial material, or a combination thereof.

Embodiment 47 provides the method of Embodiment 46 wherein the central component is approximately spheroid, toroid, ovoid, ring-shaped, square-shaped, or circular.

Embodiment 48 provides the method of any one of Embodiments 44-47, wherein at least one of the first and second components comprises a rod-receiving anchor, wherein the connecting comprises securely inserting at least one of the connecting rods into a rod-receiving anchor on the first or second component.

Embodiment 49 provides the method of Embodiment 48, wherein the rod-receiving anchor comprises a bore in the first or second component.

Embodiment 50 provides the method of any one of Embodiments 44-49, wherein the sacrificial material comprises at least two connecting rods extending therefrom, wherein the first and second components each comprise a rod-receiving anchor, wherein the connecting comprises securely inserting a connecting rod into the rod-receiving anchor on the first component and securely inserting a different connecting rod into the rod-receiving anchor on the second component.

Embodiment 51 provides the method of any one of Embodiments 30-50, wherein the first and second component independently comprise metal, metallic alloy, wood, polymer, plastic, ceramic, cement, rock, a composite, or a combination thereof.

Embodiment 52 provides the method of any one of Embodiments 30-51, wherein the first and second component comprise aerospace components, automotive components, energy industry components, or a combination thereof.

Embodiment 53 provides the method of any one of Embodiments 30-52, wherein the first component connected to the second component via the connector is an aerospace component, an automotive component, energy industry components, or a combination thereof.

Embodiment 54 provides the method of any one of Embodiments 30-53, wherein the sacrificial material comprises a polymer comprising a repeating unit comprising a substituted or unsubstituted (C₂-C₂₀)hydrocarbylene and at least one of carboxylate, carbonate, carbamate, thiocarbonate, and thiocarbamate.

Embodiment 55 provides the method of Embodiment 54, wherein the sacrificial material further comprises a catalyst.

Embodiment 56 provides the method of Embodiment 55, wherein the catalyst is about 0.001 wt % to about 30 wt % of the sacrificial material.

Embodiment 57 provides the method of any one of Embodiments 55-56, wherein the catalyst is about 0.1 wt % to about 10 wt % of the sacrificial material.

Embodiment 58 provides the method of any one of Embodiments 55-57, wherein the catalyst is aluminum oxalate, ammonium niobate(V) oxalate hydrate, ammonium oxalate, antimony oxalate, barium oxalate, beryllium oxalate, bismuth oxalate, cadmium oxalate, calcium oxalate, calcium oxalate hydrate, calcium oxalate monohydrate, cerium oxalate, cesium oxalate, chromium oxalate, cobalt oxalate, cobalt(II) oxalate dihydrate, copper oxalate, dysprosium oxalate, dysprosium(III) oxalate hydrate, erbium oxalate, erbium(III) oxalate hydrate, europium oxalate, gadolinium oxalate, gadolinium(III) oxalate hydrate, holmium oxalate, iron(II) oxalate, iron oxalate, lanthanum oxalate, lead oxalate, lithium oxalate, lutetium oxalate, lutetium oxalate hydrate, magnesium oxalate, molybdenum oxalate, neodymium oxalate, nickel oxalate, nickel(II) oxalate dihydrate, niobium oxalate, palladium oxalate, potassium oxalate anhydrous, potassium oxalate monohydrate, praseodymium oxalate, praseodymium oxalate decahydrate, rubidium oxalate, ruthenium oxalate, samarium oxalate, silver oxalate, sodium oxalate, strontium oxalate, tantalum oxalate, terbium oxalate, thulium oxalate, tin(II) oxalate, titanium oxalate, ytterbium oxalate, yttrium oxalate, zinc oxalate, zirconium oxalate, or a combination thereof.

Embodiment 59 provides the method of any one of Embodiments 55-58, wherein the metal oxalate is tin (II) oxalate.

Embodiment 60 provides the method of any one of Embodiments 54-59, wherein the polymer comprises a repeating unit that is a (C₂-C₂₀)hydrocarbylene carbonate or carboxylate, wherein the (C₁-C₂₀)hydrocarbylene is substituted or unsubstituted.

Embodiment 61 provides the method of any one of Embodiments 54-60, wherein the polymer comprises a repeating unit that is a (C₂-C₅)hydrocarbylene carboxylate.

Embodiment 62 provides the method of any one of Embodiments 54-61, wherein the polymer comprises a repeating unit that is a propylene carboxylate.

Embodiment 63 provides the method of any one of Embodiments 54-62, wherein the polymer is poly(lactic acid).

Embodiment 64 provides the method of Embodiment 63, wherein the sacrificial material further comprises tin oxide.

Embodiment 65 provides the method of any one of Embodiments 54-64, wherein the polymer comprises a repeating unit that is a (C₂-C₅)hydrocarbylene carbonate.

Embodiment 66 provides the method of any one of Embodiments 54-65, wherein the polymer comprises a repeating unit that is ethylene carbonate or propylene carbonate.

Embodiment 67 provides the method of any one of Embodiments 54-66, wherein the polymer is poly(ethylene carbonate) or polypropylene carbonate).

Embodiment 68 provides the method of any one of Embodiments 30-67, wherein the connector comprises an acid generator.

Embodiment 69 provides the method of Embodiment 68, wherein the acid generator comprises a photoacid generator.

Embodiment 70 provides the method of Embodiment 69, wherein the photoacid generator is about 0.001 wt % to about 30 wt % of the connector.

Embodiment 71 provides the method of any one of Embodiments 69-70, wherein the photoacid generator is about 0.1 wt % to about 5 wt % of the connector.

Embodiment 72 provides the method of any one of Embodiments 69-71, wherein the photoacid generator is at least one of bis(4-tert-butylphenyl)iodonium perfluoro-1-butanesulfonate, bis(4-tert-butylphenyl)iodonium p-toluenesulfonate, bis(4-tert-butylphenyl)iodonium triflate, boc-methoxyphenyldiphenylsulfonium triflate, (4-bromophenyl)diphenylsulfonium triflate, (tert-butoxycarbonylmethoxynaphthyl)-diphenylsulfonium triflate, (4-tert-butylphenyl)diphenylsulfonium triflate, diphenyliodonium, diphenyliodonium nitrate, diphenyliodonium perfluoro-1-butanesulfonate, diphenyliodonium p-toluenesulfonate, diphenyliodonium triflate, (4-fluorophenyl)diphenylsulfonium triflate, N-hydroxynaphthalimide triflate, N-hydroxy-5-norbornene-2,3-dicarboximide perfluoro-1-butanesulfonate, (4-iodophenyl)diphenylsulfonium triflate, (4-methoxyphenyl)diphenylsulfonium triflate, 2-(4-methoxystyryl)-4,6-bis(trichloromethyl)-1,3,5-triazine, (4-methylphenyl)diphenylsulfonium triflate, (4-methylthiophenyl)methyl phenyl sulfonium triflate, (4-phenoxyphenyl)diphenylsulfonium triflate, (4-phenylthiophenyl)diphenylsulfonium triflate, triarylsulfonium hexafluorophosphate, triphenylsulfonium perfluoro-1-butanesufonate, triphenylsulfonium triflate, tris(4-tert-butylphenyl)sulfonium perfluoro-1-butanesulfonate, and tris(4-tert-butylphenyl)sulfonium triflate.

Embodiment 73 provides the method of any one of Embodiments 30-72, further comprising disconnecting the first and second component comprising exposing the sacrificial material to at least one of heat and acid.

Embodiment 74 provides the method of Embodiment 73, wherein disconnecting the first and second component comprises degrading the sacrificial material, softening the sacrificial material, or a combination thereof, such that the connector no longer mechanically connects or chemically adheres the first component to the second component.

Embodiment 75 provides the method of any one of Embodiments 73-74, wherein disconnecting further comprises exposing the sacrificial material or a degraded product thereof to vacuum, solvent, or a combination thereof.

Embodiment 76 provides the method of any one of Embodiments 73-75, wherein after the disconnecting, the first component and the second component comprise substantially no sacrificial material or degradation product thereof.

Embodiment 77 provides a method of connecting components, the method comprising:

applying a connector comprising a sacrificial material to a first component, a second component, or a combination thereof, wherein

the sacrificial material is about 50 wt % to about 100 wt % of the connector,

the sacrificial material is a polymer that is poly(ethylene carbonate), poly(propylene carbonate), poly(lactic acid), or a combination thereof, and

the connector is an adhesive, a sacrificial mechanical connector, or a combination thereof;

connecting the first component and the second component via the connector; and

disconnecting the first component and the second component comprising exposing the sacrificial material to at least one of heat and acid sufficiently to degrade the sacrificial material, soften the sacrificial material, or a combination thereof, such that the connector no longer mechanically connects or chemically adheres the first component to the second component.

Embodiment 78 provides a method of disconnecting components, the method comprising:

obtaining or providing a first component and a second component connected via a connector comprising a sacrificial material; and

exposing the sacrificial material to at least one of heat and acid sufficiently to degrade the sacrificial material, soften the sacrificial material, or a combination thereof, such that the connector no longer connects the first component to the second component.

Embodiment 79 provides a method of disconnecting components, the method comprising:

obtaining or providing a first component and a second component connected via a connector comprising a sacrificial material, wherein

the sacrificial material is about 50 wt % to about 100 wt % of the connector,

the sacrificial material is a polymer that is poly(ethylene carbonate), poly(propylene carbonate), poly(lactic acid), or a combination thereof, and

the connector is an adhesive, a sacrificial mechanical connector, or a combination thereof; and

exposing the sacrificial material to at least one of heat and acid sufficiently to degrade the sacrificial material, soften the sacrificial material, or a combination thereof, such that the connector no longer mechanically connects or chemically adheres the first component to the second component.

Embodiment 80 provides a sacrificial adhesive, the adhesive comprising:

a sacrificial material comprising a polymer comprising a repeating unit comprising a substituted or unsubstituted (C₂-C₂₀)hydrocarbylene and at least one of carboxylate, carbonate, carbamate, thiocarbonate, and thiocarbamate.

Embodiment 81 provides a sacrificial adhesive, the adhesive comprising:

a sacrificial material that is poly(ethylene carbonate), poly(propylene carbonate), poly(lactic acid), or a combination thereof.

Embodiment 82 provides a sacrificial mechanical connector, the connector comprising:

a sacrificial material comprising a polymer comprising a repeating unit comprising a substituted or unsubstituted (C₂-C₂₀)hydrocarbylene and at least one of carboxylate, carbonate, carbamate, thiocarbonate, and thiocarbamate.

Embodiment 83 provides a sacrificial mechanical connector, the connector comprising:

a sacrificial material that is poly(ethylene carbonate), poly(propylene carbonate), poly(lactic acid), or a combination thereof.

Embodiment 84 provides the method, composite, sacrificial adhesive, or sacrificial mechanical connector, of any one or any combination of Embodiments 1-83 optionally configured such that all elements or options recited are available to use or select from.

What is claimed is:

1. A method of forming a cavitated material, the method comprising:
forming a precursor composite material comprising a sacrificial fiber in a curable composition, wherein the sacrificial fiber comprises a polymer comprising a repeating unit comprising a substituted or unsubstituted (C₂-C₂₀)hydrocarbylene and at least one of carbonate, carbamate, thiocarbonate, and thiocarbamate;
curing the precursor composite material, to form a composite material;
exposing the composite material to at least one of heat and acid, such that at least some of the sacrificial fibers degrade; and
removing at least some of the degraded fibers, to form a cavitated material.

2. The method of claim 1, wherein forming the precursor composite material comprises arranging the sacrificial fiber in the curable composition.

3. The method of claim 1, wherein the fibers have a diameter of about 0.001 μm to about 5 mm.

4. The method of claim 1, wherein the polymer is poly(ethylene carbonate) or poly(propylene carbonate).

5. The method of claim 1, wherein the sacrificial fibers are about 0.000,1 wt % to about 90 wt % of the precursor composite material.

6. The method of claim 1, wherein the curable composition comprises at least one of a thermoset composition, a thermoplastic composition, a polymerizable composition, and a crosslinkable composition.

7. The method of claim 1, wherein the precursor composite material further comprises an acid generator, wherein subjecting the composite material to acid comprises generating acid from the acid generator.

8. The method of claim 7, wherein the acid generator comprises a photoacid generator, wherein the generating the acid comprises exposing the acid generator to light such that the acid is formed.

9. The method of claim 1, wherein the removing comprises exposing the composite material to vacuum and heat such that at least some of the degraded fibers are removed from the composite.

10. A method of connecting components, the method comprising:
connecting a first component and a second component via a connector comprising a sacrificial material.

11. The method of claim 10, wherein the connector is an adhesive material, a mechanical connecting component, or a combination thereof.

12. The method of claim 10, wherein connecting comprises adhering the first component to the second component with the connector.

13. The method of claim 10, comprising heating the sacrificial material prior to connecting the first and second component.

14. The method of claim 10, wherein connecting comprises mechanically attaching the first component to the second component via the connector.

15. The method of claim 14, wherein the connector is a sacrificial fastener.

16. The method of claim 15, wherein the sacrificial fastener is a nail, bolt, nut, screw, clip, clamp, clasp, latch, dowel, biscuit, staple, cable, strap, thread, tie, pin, peg, hook and loop fastener, rivet, zipper, wedge anchor, or a combination thereof

17. The method of claim 10, wherein the first and second component independently comprise metal, metallic alloy, wood, polymer, plastic, ceramic, cement, rock, a composite, or a combination thereof.

18. The method of claim 10, wherein the sacrificial material comprises a polymer comprising a repeating unit comprising a substituted or unsubstituted (C₂-C₂₀)hydrocarbylene and at least one of carboxylate, carbonate, carbamate, thiocarbonate, and thiocarbamate.

19. The method of claim 18, wherein the polymer is poly(lactic acid), poly(ethylene carbonate), or polypropylene carbonate).

20. The method of claim 10, further comprising disconnecting the first and second component comprising exposing the sacrificial material to at least one of heat and acid.
